(19) United States
(12) Patent Application Publication
(10) Pub. No.: US 2011/0074272 A1
(43) Pub. Date: Mar. 31, 2011

(54) OPTICAL MEMBER

(76) Inventors: Yoshiaki Sakamoto, Ashigarakami-gun (JP); Yosuke Takeuchi, Ashigarakami-gun (JP); Hiroyuki Hiiro, Ashigarakami-gun (JP)

(21) Appl. No.: 12/889,050

(22) Filed: Sep. 23, 2010

(30) Foreign Application Priority Data
Sep. 28, 2009 (JP) 2009-222908

(51) Int. Cl. H01K 1/26

(52) U.S. Cl. 313/113

(57) ABSTRACT

The present invention provides an optical member which is disposed on the light emitting side of an organic light-emitting display device having at least a light reflective electrode and an organic EL layer, the optical member including: a light transmissive substrate, and a light transmissive layer which is formed on the light transmissive substrate and which has concave portions, wherein the optical member is disposed on the light emitting side of the organic light-emitting display device, the optical member enabling to from an optical resonator between the light reflective electrode in the organic light-emitting display device and surfaces of the concave portions opposite to the light reflective electrode, and wherein the optical resonator emits light of at least one color light selected from a red light, a green light and a blue light.

### BACKGROUND OF THE INVENTION

1. Field of the Invention

The present invention relates to an optical member.

2. Description of the Related Art

Various full-color display techniques using organic electroluminescence light emission have been disclosed. For example, Japanese Patent Application Laid-Open (JP-A) No. 2007-520060 discloses an OLED device for producing a white light which more effectively matches with the response of a multi-color filter provided in the OLED device using an organic electroluminescence. In this OLED device, a spectrum of white color light is varied by two or more different types of dopants contained in the organic EL element and selected so that the white color light more effectively matches with the response from the color filter. That is, this OLED device efficiently emits white color light by controlling the responsiveness of the color filter. However, such a configuration has a drawback of complexity in controlling of the responsiveness. In addition, to further improve optical properties by increasing the intensity of a specific wavelength, the OLED device also has a problem in that it does not have an optimum configuration.

To solve the above-mentioned problems, there have been proposed various techniques using a resonator structure which adjusts optical path lengths for each color and repeatedly performs reflection and interference of light, thereby increasing the intensity of light having a specific wavelength.

Further, Japanese Patent (JP-B) No. 3898163 discloses an organic light-emitting display device having a configuration in which direct output light which is transmissive through a transparent sealing plate having a function to protect an organic thin film and partially reflect light and which emerges upward and light returned to the device side once by reflection of the transparent sealing plate are reflected by a reflection film (e.g., a metal electrode which also serves as a total reflection mirror) provided on the substrate side disposed below the organic thin film, so that light is emitted to the upper part of the transparent sealing plate via an optical path different from the optical path of the direct output light. JP-B No. 3898163 also discloses to control optical path lengths by providing step heights and spacers for each color pixel on the side of an insulating substrate having an organic light-emitting layer. Such a configuration has a problem in that accuracy is required to control the optical path lengths. Also, there is a problem in that the number of process steps is increased because the insulating substrate having an organic light-emitting layer should be produced, and the step heights and spacers should be provided.

Further, Japanese Patent (JP-B) No. 3703028 discloses a display device having a light-emitting layer, which has a resonator structure between a first end section and a second end section sandwiching the light-emitting layer, in which a distance between the first end section and the light-emitting layer and a distance between the second end section and the light-emitting layer are defined so as to satisfy a predetermined mathematical expression. However, JP-B No. 3703028 does not disclose details on the resonator structure.

### BRIEF SUMMARY OF THE INVENTION

An object of the present invention is to provide an optical member for organic light-emitting display device, which can be produced by a simple method and which has such excellent optical properties that the intensity of light is increased at a specific wavelength.

The present inventors carried out extensive studies and examinations in an attempt to solve the above-mentioned problems and have found that an optical member is configured so that an optical resonator is formed between a light transmissive layer provided with concave portions provided having a predetermined shape and a light reflective electrode constituting an OLED substrate, thereby making it possible to solve the above-mentioned problems.

The present invention is based on the findings of the present inventors, and means for solving the above-mentioned problems are as follows:

<1> An optical member disposed on the light emitting side of an organic light-emitting display device having at least a light reflective electrode and an organic EL layer, the optical member including:

a light transmissive substrate, and

a light transmissive layer which is formed on the light transmissive substrate and which has concave portions,

wherein the optical member is disposed on the light emitting side of the organic light-emitting display device, the optical member forming an optical resonator between the light reflective electrode in the organic light-emitting display device and surfaces of the concave portions opposite to the light reflective electrode, and

wherein the optical resonator emits at least one color light selected from a red light, a green light and a blue light.

<2> The optical member according to <1> above, wherein the light transmissive layer is formed of one structural member.

<3> The optical member according to <2> above, wherein the one structural member is made of a material selected from a photocurable resin, a thermoplastic resin and a thermally curable resin.

<4> The optical member according to <1>, further comprising a light semi-transmissive reflecting layer on a surface of the light transmissive layer, in which surface the concave portions are formed.

<5> The optical member according to <1>, wherein the concave portions provided in the light transmissive layer are different in depth so that at least one of a red light, a green light and a blue light is emitted from the organic light-emitting device.

<6> The optical member according to <1> above, further including a color filter layer between the light transmissive substrate and the light transmissive layer.

<7> The optical member according to <1> above, wherein the light transmissive substrate has flexibility.

According to the present invention, it is possible to solve the above-mentioned various problems, to achieve the object and to provide an optical member for organic light-emitting display device, which can be produced by a simple method and which has such excellent optical properties that the intensity of light is increased at a specific wavelength.

### BRIEF DESCRIPTION OF THE DRAWINGS

FIG. 1 is a cross-sectional diagram illustrating one example of an organic light-emitting display device having an optical member according to the present invention.

FIG. 2 is a cross-sectional diagram illustrating another example of an organic light-emitting display device having an optical member according to the present invention.

FIG. 3 is a cross-sectional diagram illustrating still another example of an organic light-emitting display device having an optical member according to the present invention.

FIG. 4 is a cross-sectional diagram illustrating yet still another example of an organic light-emitting display device having an optical member according to the present invention.

FIG. 5 is a diagram illustrating light emission output characteristics of an organic light-emitting display device of Example 1.

FIG. 6 is a diagram illustrating light emission output characteristics of an organic light-emitting display device of Example 2.

FIG. 7 is a diagram illustrating light emission output characteristics of an organic light-emitting display device of Comparative Example.

FIG. 8 is a diagram illustrating light emission output characteristics of a color filter used in Examples and Comparative Example.

FIG. 9 is a diagram illustrating light emission output characteristics of an OLED substrate used in Examples and Comparative Example.

### DETAILED DESCRIPTION OF THE INVENTION

### (Optical Member)

An optical member according to the present invention is a member which is disposed on the light emitting side of an organic light-emitting display device and which includes a substrate for OLED substrate, a light transmissive substrate which is different from the substrate for OLED substrate, and a light transmissive layer which is formed on the light transmissive substrate and which has concave portions, and further includes other members as required.

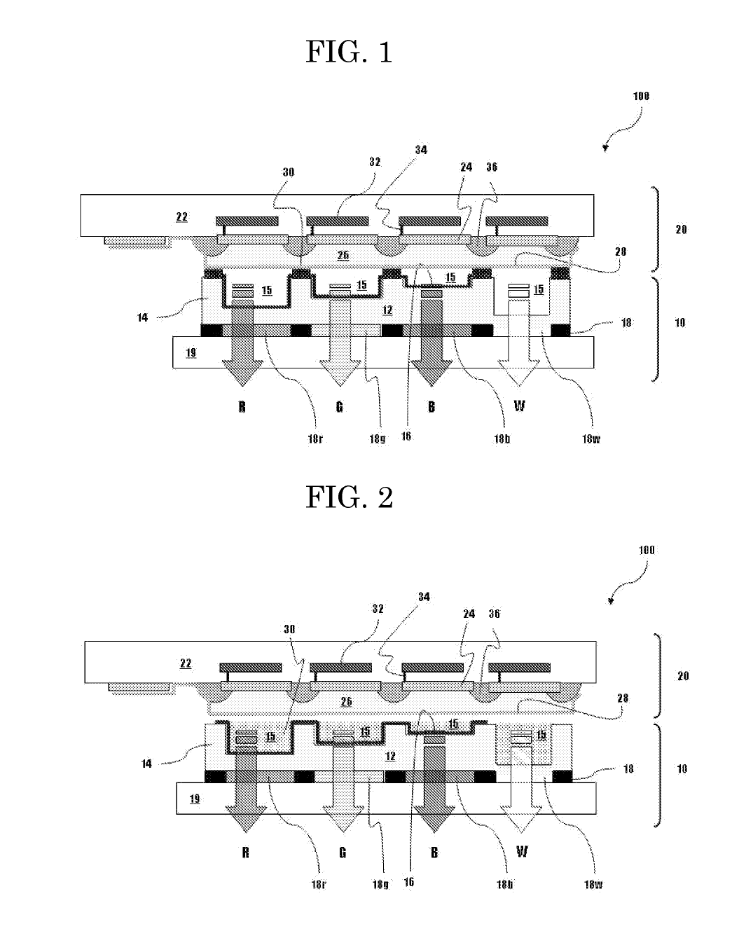

The optical member is not particularly limited as to the structure, shape and size and the like, as long as it can be used in the organic electroluminescence display device, and may be suitably selected in accordance with the intended use. Hereinafter, the optical member will be described with reference to FIGS. 1 to 4 each illustrating one aspect of the application of an optical member. An optical member 10 has a concave-convex section composed of convex portions and concave portions, one a light transmissive layer, as indicated by reference numerals 14 and 15 in FIGS. 1 to 4.

The shape of the concave portions is not particularly limited, as long as they are provided so as to correspond to each of color pixels, and may be suitably selected in accordance with the intended use. For example, the concave portions may be formed in a row along a width direction and/or a longitudinal direction of the optical member, or may be formed in a zig-zag manner with respect to a width direction and/or a longitudinal direction of the optical member. The step height of the convex portions 14 and the depth of the concave portions 15 are not particularly limited and may be suitably selected in accordance with the intended use. However, it is preferable that the convex portions 14 and the concave portions 15 preferably have two or more depths (two or more heights), from the viewpoint that the intensity of light emitted from the OLED substrate is optimized and the light emission intensity of light having a specific wavelength is more increased.

In the organic electroluminescence display device, the configuration of concave portions of the light transmissive layer in the optical member is not particularly limited, as long as they do not influence on optical properties of light emitted from the organic EL layer in the organic electroluminescence display device, and may be suitably selected in accordance with the intended use. However, from the viewpoint of alleviating the processing accuracy of the depths of concave portions forming the optical resonator length L, the refractive index of each concave portion of the light transmissive layer is preferably smaller than that of the light transmissive electrode. From the viewpoint of capability of stably forming the after-mentioned optical resonator, the refractive index of each concave portion of the light transmissive layer is preferably equal to that of the light transmissive electrode. In the organic electroluminescence display device, as the configuration of concave portions of the light transmissive layer in the optical member, the concave portions of the light transmissive layer is preferably a void volume having a refractive index equivalent to the refractive index of air (refractive index=1) at the light emitting side, from the viewpoints of alleviating the processing accuracy of depths of concave portions forming the optical resonator length L and reducing refraction/reflection losses of emission of light passing through the optical member. The range of refractive indices equivalent to the refractive index 1 of air is not particularly limited and may be suitably selected in accordance with the intended use. However, it is preferably from 1.0 to 1.1 from the viewpoint of reducing a difference in refractive index between the front surface and the rear surface of the optical member. The refractive indices of concave portions are measured by the ellipsometry method, for example, using an Abbe refractometer (manufactured by Atago Co., Ltd.) or the like.

The method of forming concave portions is not particularly limited and may be suitably selected in accordance with the intended use. Examples thereof include an extrusion molding method using a mold (die, plate), a die transfer method and an imprint method. Among these, an imprint method using a mold is preferable for its high accuracy and excellent processability. An aspect of forming concave portions is not particularly limited and may be suitably selected in accordance with the intended use, however, when the imprint method using a mold is employed, concave portions may be formed by pressing the after-mentioned mold for forming concave-convex section against the surface of the light transmissive substrate, a light transmissive layer formed on a color filter layer, or a light semi-transmissive reflecting layer so as to form a desired concave-convex-shape pattern. Also, a light transmissive layer having, on its surface, a concave-convex shape formed in this way may be cured under appropriate conditions (e.g., UV irradiation, heating). Since the light transmissive substrate of the optical member has light transmissivity, the light transmissive layer may be cured by irradiation with an UV-ray via the light transmissive substrate. When the optical member has a color filter layer, registration may be performed so that concave potions respectively correspond to a red color-filter portion, a green color-filter portion, a blue color-filter portion and a white color-filter portion constituting the color filter layer 18, and thereby desired concave portions are formed.

### —Mold for Forming Concave-Convex Section—

The method of forming the mold for forming a concave-convex section for use in forming the concave portions in the optical member is not particularly limited and may be suitably selected in accordance with the intended use. Examples thereof include lithography using an electron beam (EB), etching, and laser writing. Among these, the method is preferably a lithographic method and a dry-etching method each employed to a quartz substrate, from the view point of achieving UV irradiation from the mold side irrespective of the UV transmissivity of the light transmissive substrate. These methods may be used alone or in combination.

By way of example of the method of forming the mold for forming a concave-convex section, a quarts substrate may be caused to have openings, in its surface, at predetermined positions and etched to a predetermined depth by a photolithographic process using a photosensitive resist on the quartz substrate. When concave portions are to be formed in the optical member so as to have two or more depths, a quartz substrate is caused to have openings, in its surface by a photolithographic method as described above, and then the etching depth may be adjusted by controlling the conditions for dry etching. For example, when a multistep concave-convex section is formed as illustrated in the optical members in FIGS. 1 and 2, in the mold for forming a concave-convex section, the region corresponding to a concave portion for green color is etched 16 nm to 30 nm in depth from the surface of the quartz substrate, the region corresponding to a concave portion for blue color is etched 27 nm to 50 nm in depth from the surface of the quartz substrate, the region corresponding to a convex portion for partitioning pixels is etched 33 nm to 60 nm in depth from the surface of the quartz substrate, and the region corresponding to a concave portion for red color may be left remaining, without being etched. In addition, the region corresponding to a concave portion for white color may be etched to be a concave portion having a depth deeper than the concave portion for red color or may not be etched without providing any concave portion. When the concave portion for white color is deeper than the concave portion for red color, the surface of the quartz substrate is left intact. When there is no concave portion for white color in the optical member, the corresponding region of the quartz substrate may be subjected to processing in a similar manner to the region corresponding to the convex portion for partitioning pixels. In this way, a mold for forming a concave-convex section can be obtained. Note that, after the optical member is imprinted with this mold for forming a concave-convex section, the regions of the optical member for forming a concave portion and a convex portion respectively correspond to a convex portion and a concave portion formed in the surface of the quartz substrate.

### <<Light Transmissive Layer>>

In the optical member, the light transmissive layer is not particularly limited, as long as it transmits light emitted from the after-mentioned OLED substrate, and may be suitably selected in accordance with the intended use. The light transmissive layer is preferably formed of one member. With this configuration, convex portions and concave portions are integrally formed into one unit, and it is preferable in terms of easy production that the arrangement and the step height each of the concave and convex portions can be easily controlled. The thickness of the light transmissive layer is not particularly limited and may be suitably adjusted in accordance with the intended use. The thickness thereof may be 1 μm to several micrometers. Particularly, what is required for the thickness of the light transmissive layer is that it is formed thicker than the maximum step height of concave-convex portions of the after-mentioned mold for forming concave and convex portions.

The material for use in the light transmissive layer is not particularly limited and may be suitably selected in accordance with the intended use. Examples thereof include various photo-curable resins, various thermoplastic resins, and various thermally curable resins. Examples of the photocurable resins include unsaturated polyester resins, polyester acrylate resins, urethane acrylate resins, silicone acrylate resins, and epoxy acrylate resins. Examples of the thermoplastic resins include polyethylene, polyester, polystyrene, and polycarbonate. Examples of the thermally curable resins include silicone-based resins, phenoxy resins, and epoxy resins. As the material for the light transmissive layer, other materials containing a polymerization initiator may be used.

In the optical member, the method of producing the light transmissive layer is not particularly limited, as long as the above-mentioned requirements are satisfied, and may be suitably selected in accordance with the intended use. For example, it may be a method in which the after-mentioned light transmissive layer is laminated on the after-mentioned light transmissive substrate or the after-mentioned color filter layer by spin-coating, extrusion coating, bar-coating, gravure coating or roll coating to thereby form concave-convex section on the light transmissive layer.

### <<Light Transmissive Substrate>>

In the optical member, the light transmissive substrate is not particularly limited, as long as it transmits light emitted from the after-mentioned OLED substrate, and may be suitably selected in accordance with the intended use. The shape, structure, size and the like of the light transmissive substrate are not particularly limited, as long as this purpose can be satisfied, and may be suitably selected in accordance with the intended use. In general, the light transmissive substrate preferably has a plate shape. The light transmissive substrate may have a single-layered structure or a multi-layered structure, and may be formed of a single material or two or more materials. Although the light transmissive substrate may be colorless transparent or may be colored transparent, it is preferably colorless transparent in terms of no scattering or attenuation of the light emitted from the light-emitting layer. In addition, the substrate preferably has flexibility in terms of the convenience.

The arrangement (location) of the light transmissive substrate is not particularly limited, as long as it supports the light transmissive layer and concave and convex portions are provided on the upper surface thereof. Especially, the light transmissive substrate is preferably disposed in a light emitting direction of light emitted from the organic electroluminescence display device as viewed from the light transmissive layer of the optical member.

The material for use in the light transmissive substrate is not particularly limited and may be suitably selected in accordance with the intended use. Specific examples thereof include inorganic materials (e.g., glass); and organic materials such as polyesters (e.g., polyethylene terephthalate, polybutylene phthalate, and polyethylene naphthalate), polystyrene, polycarbonate, polyether sulfone, polyacrylate, polyimide, polycycloolefin, norbornene resins, and poly(chlorotrifluoroethylene).

For example, when glass is used as the light transmissive substrate, it is preferable to use an alkali-free glass, because it is necessary to reduce ions eluted from glass. Further, when soda lime glass is used, it is preferable to use a material provided with a barrier coat such as silica. In the case of organic materials, materials excellent in heat resistance, dimensional stability, solvent resistance, electrical insulating properties and processability are preferably used.

When a thermoplastic substrate is used as the light transmissive substrate, a hard coat layer and an undercoat layer for a barrier film substrate may further be provided.

### <<Other Members>>

### <<<Light Semi-Transmissive Reflecting Layer>>>

In the optical member, a light semi-transmissive reflecting layer, which transmits a part of light beams traveling in the light emitting direction of the above-mentioned organic electroluminescence display device as viewed from the after-mentioned OLED substrate and which reflects light other than the part of light, may be provided on the light transmissive layer of the optical member. That is, as indicated by reference numeral 16 in FIGS. 1 to 4, the light semi-transmissive reflecting layer may be provided on a surface of the light transmissive layer 12 having a concave-convex section composed of the convex portions 14 and the concave portions 15. The structure, shape, size and the like of the light semi-transmissive reflecting layer is not particularly limited and may be suitably selected in accordance with the intended use. The material for use in the light semi-transmissive reflecting layer is not particularly limited, as long as it satisfies the above-mentioned aspects, and may be suitably selected in accordance with the intended use. Examples thereof include thin films formed of Ag or Al. Although the thickness of the light semi-transmissive reflecting layer is not particularly limited and may be suitably adjusted in accordance with the intended use, it is preferably 10 nm to 30 nm from the viewpoint of the balance between the transmittance and the reflectance. The method of providing the light semi-transmissive reflecting layer on a surface of the light transmissive layer is not particularly limited, as long as it is a known method in the art, and may be suitably selected in accordance with the intended use. Examples of the method include a dry film-forming method (e.g., a vapor deposition method and a sputtering method), a transfer method, a printing method, a coating method, an ink-jet method, and a spray method. Among these, a dry film-forming method is preferably employed in terms of controlling the thickness uniformly, and a vapor deposition method is more preferably employed in terms of causing no damage on the light transmissive layer.

### <<Color Filter Layer>>

In the optical member, a color filter layer, which transmits light beams having a specific wavelength among light beams traveling in the light emitting direction of the above-mentioned organic electroluminescence display device as viewed from the after-mentioned OLED substrate, may be provided. The shape, structure, size and the like of the color filter layer are not particularly limited and may be suitably selected in accordance with the intended use. For example, as indicated by reference numeral 18 in FIGS. 1 to 4, a color filter layer having a laminar shape is exemplified. Although, the thickness of the color filter layer is not particularly limited and may be suitably selected in accordance with the intended use, it is preferably 10 nm to 10 μm, from the viewpoint of controlling color densities. The location to dispose the color filter layer is not particularly limited and may be suitably selected in accordance with the intended use. It is, however, preferable that the color filter layer be provided between the light transmissive substrate and the light transmissive layer in the optical member. The method of forming the color filter layer is not particularly limited and may be suitably selected in accordance with the intended use. Examples of the method include a photographic method in which a fine pattern is formed on the light transmissive substrate of the optical member by exposing and developing a photosensitive composition; and an inkjet method.

The organic electroluminescence display device preferably includes a plurality of pixels, in terms of capability of full-color display. The configuration of one pixel among the plurality of pixels is not particularly limited and may be suitably selected in accordance with the intended use. The plurality of pixels may include sub-pixels corresponding to primary three colors of red, blue and green, or may include sub-pixels corresponding to primary three colors of red, blue and green and a sub-pixel corresponding to white color. The structure of the color filter layer is not particularly limited and may be suitably selected in accordance with the intended use. The color filter layer may be structured so as to correspond to the above-mentioned configuration of pixels, for example, as illustrated in FIGS. 1 to 4, may be structured to include a red color-filter portion 18r, a green color-filter portion 18g, a blue color-filter portion 18b and a white color-filter portion 18w.

### (Organic Light-Emitting Display Device)

An organic light-emitting display device, in which the optical member of the present invention can be used, includes an OLED substrate, and an optical member having on its surface a concave-convex section, and further includes other members as required.

The organic light-emitting display device is not particularly limited as to the shape, structure, and size, and may be suitably selected in accordance with the intended use. Exemplary aspects of the organic light-emitting display device will be described with reference to drawings accompanied herewith.

FIGS. 1 to 4 are cross-sectional schematic diagrams each illustrating one example of an organic electroluminescence display device according to the present invention. An organic electroluminescence display device 100 includes an OLED substrate 20 serving as a light source and an optical member 10 having, in its surface, a concave-convex section composed of convex portions 14 and concave portions 15.

The optical member 10 includes a light transmissive substrate 19 having light transmissivity which is different from the after-mentioned substrate 22 of the OLED substrate 20, a light transmissive layer 12 laminated on the light transmissive substrate 19, and the concave-convex section composed of the convex portions 14 and the concave portions 15 at the upper surface of the light transmissive layer 12.

The OLED substrate 20 includes a substrate 22, light reflective electrodes 24 having light reflectivity and laminated on the substrate 22, an organic EL layer 26 generating light and laminated on the light reflective electrodes 24 and a light transmissive electrode 28 having light transmissivity and laminated on the organic EL layer 26.

Note that in FIGS. 1 to 4, reference numeral 32 denotes an pixel circuit which controls power distribution of electrodes and the like; reference numeral 34 denotes a contact hole; and reference numeral 36 denotes an insulating layer which electrically separates adjacent electrodes from each other to define one pixel or one sub-pixel. Further, each arrow indicated by R, G, B or W denotes a direction of light emitted from the organic electroluminescence display device 100. In FIGS. 1 to 4, the optical member 10 appears to be separated from the OLED substrate 20, however, this is illustrated for convenience for describing the configuration of the organic electroluminescence display device 100.

### <Bonding Portion>

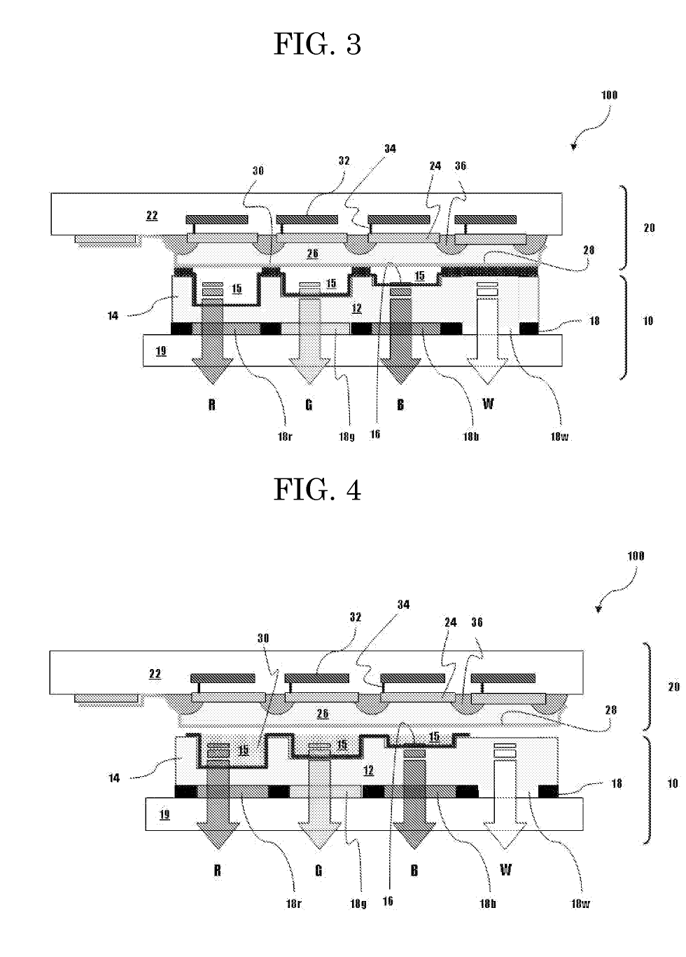

In the organic electroluminescence display device 100, the optical member 10 and the OLED substrate 20 are fixed at a position between the light transmissive electrode 28 and the light transmissive layer 12, via bonding portions 30, so as to face each other. An aspect of arrangement thereof facing each other is not particularly limited and may be suitably selected in accordance with the intended use. For example, the convex portions 14 of the light transmissive layer 12 provided in the optical member 10 and the light transmissive electrode 28 provided in the OLED substrate 20 may be disposed facing each other. As the method of fixing them facing each other, as illustrated in FIGS. 1 and 3, the convex portions 14 of the light transmissive layer 12 may be fixed so as to face the light transmissive electrode 28 of the OLED substrate 20 via the bonding portions 30. In addition, as illustrated in FIGS. 2 and 4, the convex portions 14 of the light transmissive layer 12 may be fixed so as to face the light transmissive electrode 28 of the OLED substrate 20 via a material of the bonding portions 30 filled in the concave portions 15 of the optical member 10. With this configuration, the optical member 10 and the OLED substrate 20 constitute and form the organic electroluminescence display device 100.

In the configuration illustrated in FIGS. 1 and 3, the method of fixing the convex portions 14 of the light transmissive layer 12 so as to face the light transmissive electrode 28 of the OLED substrate 20 via the bonding portions 30 is not particularly limited and may be suitably selected in accordance with the intended use, however, it is preferably a method of combining them on a molecular level from the viewpoint of easily adjusting the optical distance such as an optical path length in the organic electroluminescence display device 100. Examples of the method include a method of combining them using a silane coupling agent, etc.

In the configuration illustrated in FIGS. 2 and 4, the method of fixing the convex portions 14 of the light transmissive layer 12 so as to face the light transmissive electrode 28 of the OLED substrate 20 via a material of the bonding portions 30 filled in the concave portions 15 of the optical member 10 is not particularly limited and may be suitably selected in accordance with the intended use. For example, it may be a method of filling the concave portions 15 of the optical member 10 with an adhesive (e.g., an acryl-based or epoxy-based adhesive, and polyvinyl alcohol) to thereby bond the optical member 10 and the OLED substrate 20 via the adhesive. The method of filling the concave portions 15 with an adhesive is not particularly limited and may be suitably selected in accordance with the intended use. Examples of the method include a coating method, a printing method and an inkjet method. Among these methods, an inkjet method is preferably employed in that predetermined portions can be filled with an adhesive in a desired amount by a simple method.

The amount of an adhesive used to fill predetermined portions according to an inkjet method is not particularly limited and may be suitably selected in accordance with the intended use. The fill amount of the concave portions with an adhesive may be adjusted according to the volumetric capacity of the concave portions so that the adhesive does not ooze from the concave portions. Examples of the scheme to adjust the fill amount are as follows. That is, when the pixel size is 200 μm×50 μm, and each depth of the concave portions corresponding to each color of R, G and B is defined as (R portion=33 nm to 60 nm), (G portion=17 nm to 30 nm), and (B portion=6 nm to 10 nm), the volumetric capacity of the concave portions corresponding to each color of R, G and B is (R portion=0.33 pl to 0.6 pl), (G portion=0.17 pl to 0.3 pl), and (B portion=0.06 pl to 0.1 pl). Accordingly, the fill amount may be adjusted so that each of the concave portions is filled with the adhesive in each of these amounts.

An aspect of filling the concave portions with an adhesive according to an inkjet method is not particularly limited and may be suitably selected in accordance with the intended use. However, when concave portions each corresponding to pixels formed for each color are arranged near in the same array, the same amount of adhesive may be filled into between concave portions corresponding to the same color pixels arranged continuously. At this time, for example, when concave portions for 100 pixels are communicated to each other, in terms of the above-mentioned example, the volumetric capacity of the concave portions corresponding to each color of R, G and B is (R portion=33 pl to 60 pl), (G portion=17 pl to 30 pl), and (B portion=6 pl to 10 pl). The amount of an adhesive described above may be jetted at appropriate times according to the amount of discharge as inkjet. In the case of an inkjet of 1 pl per discharge, an adhesive can be filled in an amount fitted to the volumetric capacity of each of the concave portions corresponding to each color by discharging the adhesive thereinto at the times: (R portion=33 times to 60 times), (G portion=17 times to 30 times), and (B portion=6 times to 10 times). In this way, concave portions corresponding to each of the same color pixels may be communicated to each other by a multiple value of the smallest unit of adhesive droplets discharged so that the volumetric capacity of concave portions for each color pixel is a multiple value of the smallest unit of droplets of the adhesive.

### —Optical Resonator—

In the organic electroluminescence display device 100, between the surface of each of the concave portions 15 formed in the light transmissive layer 12 of the optical member 10, the surface opposing to the light transmissive electrode 28, and the light transmissive electrode 28, a so-called optical resonator structure (microcavity structure) generated by reflection/interference of light emitted from the OLED substrate 20 is formed. The optical resonator is not particularly limited, as long as it can reflect and interfere with light emitted from the OLED substrate, and may be suitably selected in accordance with the intended use. For example, the optical resonator may be formed between each of the light reflective electrodes 24 laminated on the substrate 22 of the OLED substrate 20 and the after-mentioned light semi-transmissive reflecting layer 16 formed on the light transmissive layer 12 of the optical member 10. Especially, it is preferable that an optical resonator length L of the optical resonator be a multiple value of one-half wavelength of a peak wavelength (λ) of emitted light ((λ/2)×m; m is a nonnegative integer), from the viewpoint of capability of increasing the light emission intensity of light having a specific wavelength. With this configuration, the organic electroluminescence display device which has an increased color intensity owing to multiple interference and can emit light with a higher light intensity can be obtained. With forming an optical resonator in this way, at least one color light of specific color lights of red, green, blue, etc. transmits through the resonator from the light transmissive layer and is emitted in a light emitting direction of the organic electroluminescence display device.

### <OLED Substrate>

The OLED substrate includes a substrate, light reflective electrodes, an organic EL layer and a light transmissive electrode, the light reflective electrodes, organic EL layer and light transmissive electrode being laminated in this order on the substrate, and includes other members as required. Note that in the present invention, the term “OLED substrate” is a general term for a substrate having a layer emitting light in an organic electroluminescence display device which includes at least a light reflective electrode and an organic EL layer.

### <<Organic EL Layer>>

The organic EL layer is not particularly limited, as long as it can emits light by applying an electric filed, and may be suitably selected in accordance with the intended use. In particular, an organic EL layer capable of emitting white color light is preferable in that there is no need to control a white balance and it can be easily produced.

Although the organic EL layer may be made of an organic light-emitting material or may be made of an inorganic light-emitting material, an organic light-emitting material is preferable in terms of the light emission efficiency, and capabilities of increasing the size of devices, low voltage driving and production processes under low-temperature environments. Hereinafter, an organic compound layer which has a light-emitting layer using an organic light-emitting material will be described.

### —Organic Compound Layer—

As a lamination pattern of the organic compound layer, preferably, a hole-transport layer, an organic light-emitting layer and an electron transport layer are laminated in this order from the anode side. Moreover, a hole-injection layer is provided between the hole-transport layer and the cathode, and/or an electron-transportable intermediate layer is provided between the organic light-emitting layer and the electron transport layer. Also, a hole-transportable intermediate layer may be provided between the organic light-emitting layer and the hole-transport layer. Similarly, an electron-injection layer may be provided between the cathode and the electron-transport layer. Note that each layer may be composed of a plurality of secondary layers. The organic light-emitting layer corresponds to the light-emitting layer, and the anode, the cathode and the other layers than the organic light-emitting layer correspond to the above other layers.

The layers constituting the organic compound layer can be suitably formed by any of a dry film-forming method (e.g., a vapor deposition method and a sputtering method), a transfer method, a printing method, a coating method, an ink-jet method and a spray method. Among these methods, a vapor deposition method is preferable in terms of the longer operating life and throughput property of organic electroluminescent elements.

The production of an organic light-emitting layer using a vapor deposition method is not particularly limited, as long as the configuration described above can be achieved, and may be suitably selected in accordance with the intended use. The conditions for vapor deposition are not particularly limited and may be suitably selected in accordance with the intended use, however, the vapor deposition rate is preferably 8 nm/sec or higher, more preferably 10 nm/sec or higher, and particularly preferably 15 nm/sec or higher. When the vapor deposition rate is lower than 8 nm/sec, the amount of carriers trapped in the organic light-emitting layer is reduced, resulting in a reduction in external quantum efficiency and the half-life thereof.

The organic electroluminescence display device of the present invention includes at least one organic compound layer including an organic light-emitting layer. Examples of the other organic compound layers than the organic light-emitting layer include a hole-transport layer, an electron transport layer, a hole blocking layer, an electron blocking layer, a hole injection layer and an electron injection layer.

In the organic electroluminescence display device of the present invention, the layers constituting the organic compound layer can be suitably formed by any of a dry film-forming method (e.g., a vapor deposition method and a sputtering method), a wet film-forming method, a transfer method, a printing method and an ink-jet method.

The organic light-emitting layer is a layer having the functions of receiving holes from the anode, the hole injection layer, or the hole-transport layer, and receiving electrons from the cathode, the electron-injection layer, or the electron transport layer, and providing a field for recombination of the holes with the electrons for light emission, when an electric field is applied.

The light-emitting layer may be composed only of a light-emitting material, or may be a layer formed from a mixture of a host material and a dopant material. The dopant material may be a light-emitting material, and the light emitting dopant may be fluorescent or phosphorescent light-emitting material, and may contain two or more species. The host material is preferably a charge-transporting material. The host material may contain one or more species, and, for example, is a mixture of an electron-transporting host material and a hole-transporting host material. Further, a material which does not emit light nor transport any charge may be contained in the organic light-emitting layer.

Further, the organic light-emitting layer may be composed of a single layer or two or more layers, and each of the plurality of layers may emit a different light color. In particular, the layers constituting the light-emitting layer of the organic EL layer are preferably disposed at a distance from light reflective electrodes so that an optical length L′ of light emitted from the light reflective electrodes of the OLED substrate satisfies the following equation, from the viewpoint of achieving excellent light-emission efficiency.

L′=(λ/4)×(2n−1)

(λ represents a peak wavelength of emitted light; and n is a nonnegative integer)

The method of configuring the light-emitting layer so that the optical length L′ satisfies the above-mentioned relationship is not particularly limited and may be suitably selected in accordance with the intended use. However, the thicknesses of organic EL layers constituting the OLED substrate may be suitably adjusted, for example, the thickness of the hole injection layer and the thickness of each of the layers constituting the light-emitting layer may be adjusted.

The above light-emitting dopant may be, for example, a phosphorescent light-emitting material (phosphorescent light-emitting dopant) and a fluorescent light-emitting material (fluorescent light-emitting dopant).

The organic light-emitting layer may contain two or more different light-emitting dopants for improving color purity and/or expanding the wavelength region of light emitted therefrom. From the viewpoint of drive durability, it is preferred that the light-emitting dopant is those satisfying the following relation(s) with respect to the above-described host compound: i.e., 1.2 eV>difference in ionization potential (ΔIp)>0.2 eV and/or 1.2 eV>difference in electron affinity (ΔEa)>0.2 eV.

The fluorescent light-emitting material is not particularly limited and may be appropriately selected according to the intended use. Examples thereof include complexes containing a transition metal atom or a lanthanoid atom.

The transition metal atom is not particularly limited and may be selected according to the intended use. Preferred are ruthenium, rhodium, palladium, tungsten, rhenium, osmium, iridium gold, silver, copper and platinum. More preferred are rhenium, iridium and platinum. Particularly preferred are iridium and platinum.

The lanthanoid atom is not particularly limited and may be appropriately selected according to the intended use. Examples thereof include lanthanum, cerium, praseodymium, neodymium, samarium, europium, gadolinium, terbium, dysprosium, holmium, erbium, thulium, ytterbium and lutetium, with neodymium, europium and gadolinium being preferred.

Examples of ligands in the complex include those described in, for example, “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKIKINZOKUKAGAKU-KISO TO OUYOU-(Metalorganic Chemistry—Fundamental and Application—)” authored by Akio Yamamoto, published by Shokabo Publishing Co., Ltd. in 1982.

Preferred examples of the ligands include halogen ligands (preferably, chlorine ligand), aromatic carbon ring ligands (preferably 5 to 30 carbon atoms, more preferably 6 to 30 carbon atoms, still more preferably 6 to 20 carbon atoms, particularly preferably 6 to 12 carbon atoms, such as cyclopentadienyl anion, benzene anion and naphthyl anion); nitrogen-containing hetero cyclic ligands (preferably 5 to 30 atoms, more preferably 6 to 30 carbon atoms, still more preferably 6 to 20 carbon atoms, particularly preferably 6 to 12 carbon atoms, such as phenyl pyridine, benzoquinoline, quinolinol, bipyridyl and phenanthroline), diketone ligands (e.g., acetyl acetone), carboxylic acid ligands (preferably 2 to 30 carbon atoms, more preferably 2 to 20 carbon atoms, still more preferably 2 to 16 carbon atoms, such as acetic acid ligand), alcoholate ligands (preferably 1 to 30 carbon atoms, more preferably 1 to 20 carbon atoms, particularly preferably 6 to 20 carbon atoms, such as phenolate ligand), silyloxy ligands (preferably 3 to 40 carbon atoms, more preferably 3 to 30 carbon atoms, still more preferably 3 to 20 carbon atoms, such as trimethyl silyloxy ligand, dimethyl tert-butyl silyloxy ligand and triphenyl silyloxy ligand), carbon monoxide ligand, isonitrile ligand, cyano ligand, phosphorus ligand (preferably 3 to 40 carbon atoms, more preferably 3 to 30 carbon atoms, still more preferably 3 to 20 carbon atoms, particularly preferably, 6 to 20 carbon atoms, such as triphenyl phosphine ligand), thiolate ligands (preferably 1 to 30 carbon atoms, more preferably 1 to 20 carbon atoms, still more preferably 6 to 20 carbon atoms, such as phenyl thiolate ligand) and phosphine oxide ligands (preferably 3 to 30 carbon atoms, more preferably 8 to 30 carbon atoms, particularly preferably 18 to 30 carbon atoms, such as triphenyl phosphine oxide ligand), with nitrogen-containing hetero cyclic ligand being more preferred.

The above-described complexes may be a complex containing one transition metal atom in the compound, or a so-called polynuclear complex containing two or more transition metal atoms. In the latter case, the complexes may contain different metal atoms at the same time.

Among these, specific examples of the light-emitting dopants include phosphorescence luminescent compounds described in Patent Literatures such as U.S. Pat. No. 6,303,238B1, U.S. Pat. No. 6,097,147, WO00/57676, WO00/70655, WO01/08230, WO01/39234A2, WO01/41512A1, WO02/02714A2, WO02/15645A1, WO02/44189A1, WO05/19373A2, JP-A Nos. 2001-247859, 2002-302671, 2002-117978, 2003-133074, 2002-235076, 2003-123982 and 2002-170684, EP1211257, JP-A Nos. 2002-226495, 2002-234894, 2001-247859, 2001-298470, 2002-173674, 2002-203678, 2002-203679, 2004-357791, 2006-256999, 2007-19462, 2007-84635 and 2007-96259. Among these, Ir complexes, Pt complexes, Cu complexes, Re complexes, W complexes, Rh complexes, Ru complexes, Pd complexes, Os complexes, Eu complexes, Tb complexes, Gd complexes, Dy complexes and Ce complexes are preferred, with Ir complexes, Pt complexes and Re complexes being more preferred. Among these, Ir complexes, Pt complexes, and Re complexes each containing at least one coordination mode of metal-carbon bonds, metal-nitrogen bonds, metal-oxygen bonds and metal-sulfur bonds are still more preferred. Furthermore, Ir complexes, Pt complexes, and Re complexes each containing a tri-dentate or higher poly-dentate ligand are particularly preferred from the viewpoints of, for example, light-emission efficiency, drive durability and color purity.

The fluorescence luminescent dopant is not particularly limited and may be appropriately selected according to the intended use. Examples thereof include benzoxazole, benzimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidyne compounds, condensed polycyclic aromatic compounds (e.g., anthracene, phenanthroline, pyrene, perylene, rubrene and pentacene), various metal complexes (e.g., metal complexes of 8-quinolinol, pyrromethene complexes and rare-earth complexes), polymer compounds (e.g., polythiophene, polyphenylene and polyphenylenevinylene), organic silanes and derivatives thereof.

Specific examples of the luminescent dopants include the following compounds, which should be construed as limiting the present invention thereto.

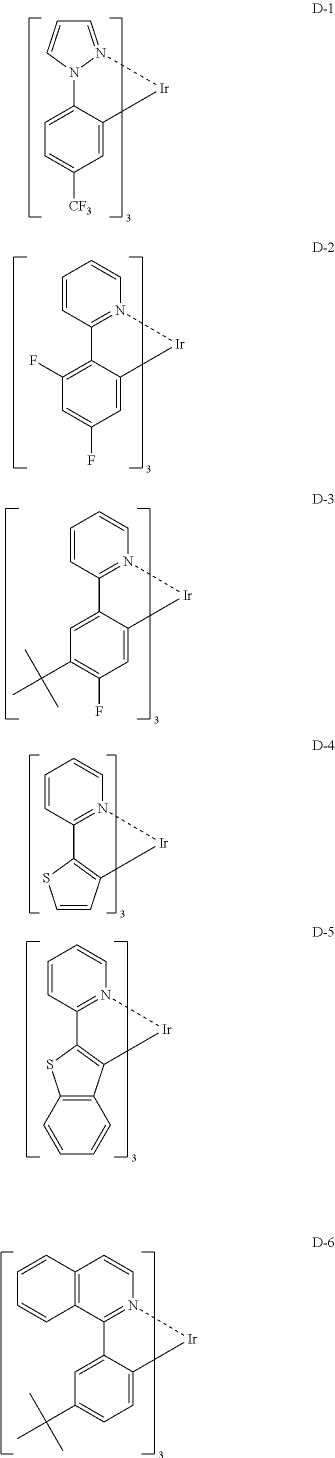

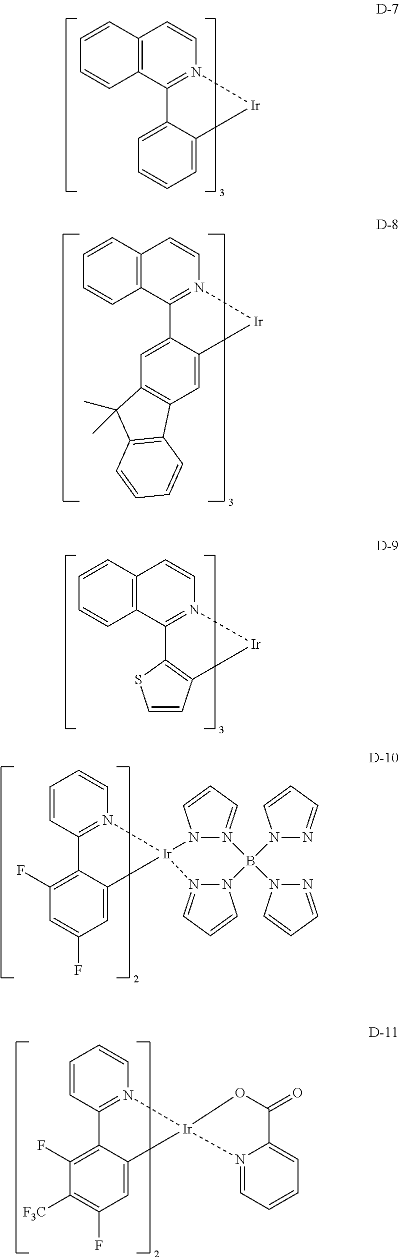

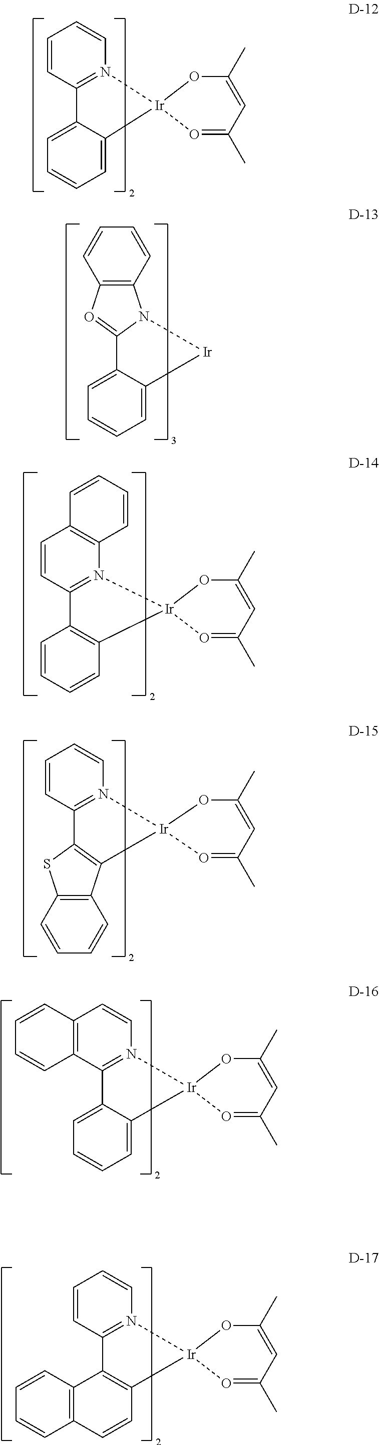

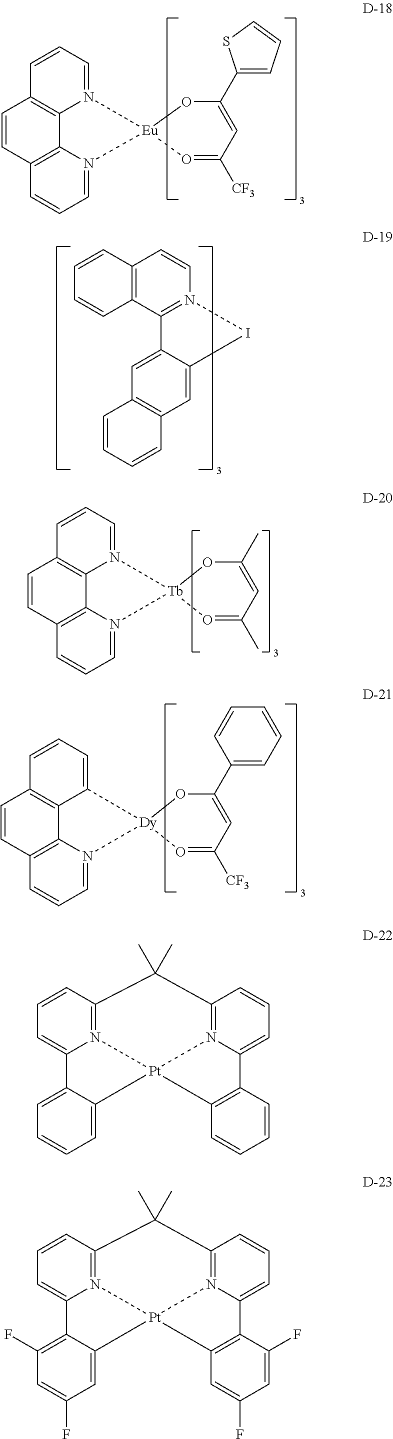

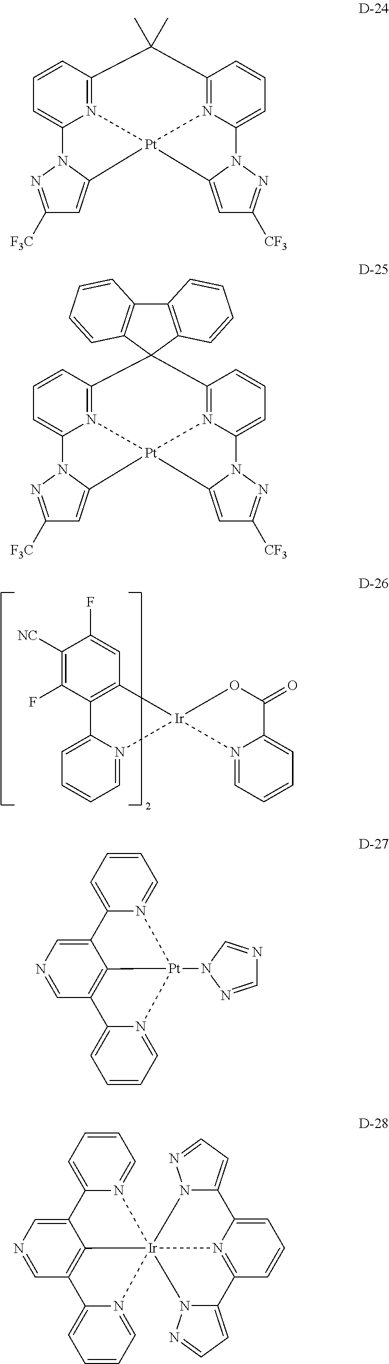

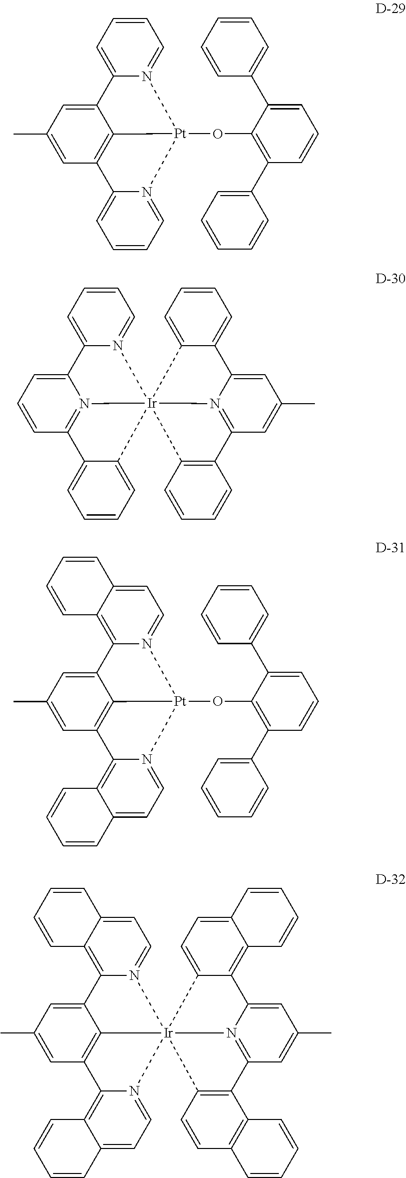

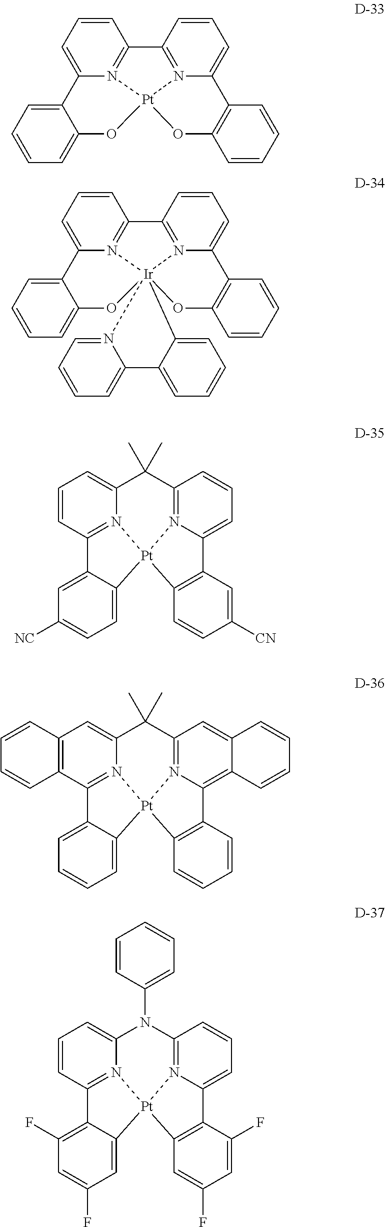

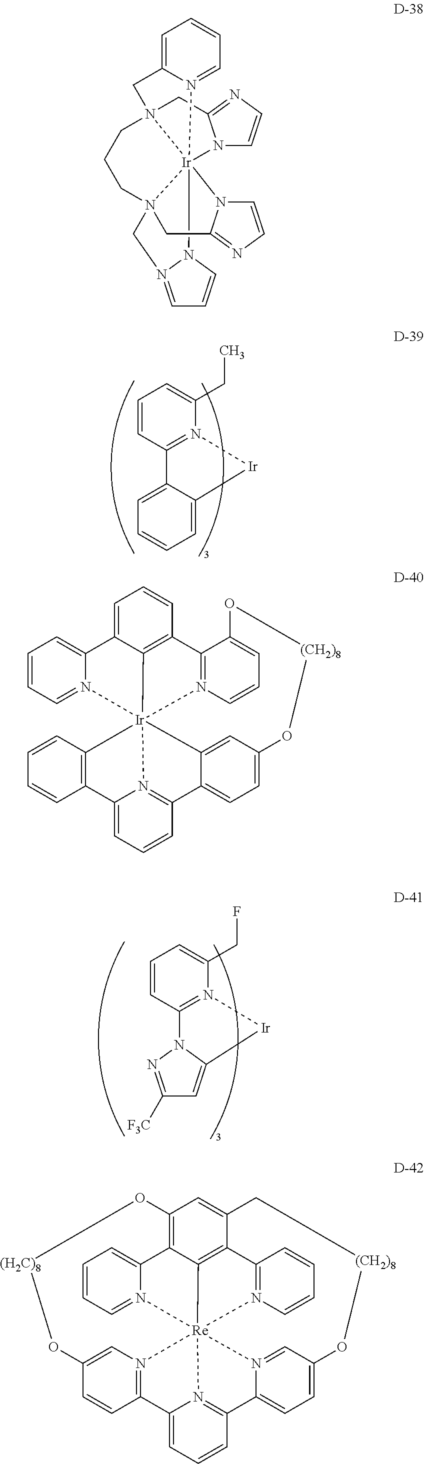

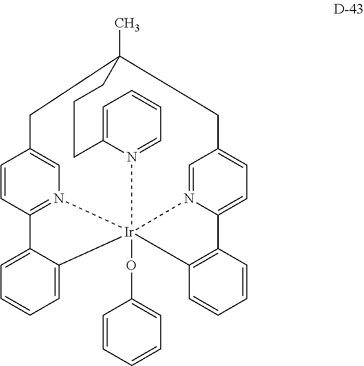

The light-emitting dopant is contained in the light-emitting layer in an amount of 0.1% by mass to 50% by mass with respect to the total amount of the compounds generally forming the light-emitting layer. From the viewpoints of drive durability and external light-emission efficiency, it is preferably contained in an amount of 1% by mass to 50% by mass, more preferably 2% by mass to 40% by mass.

Although the thickness of the light-emitting layer is not particularly limited, in general, it is preferably 2 nm to 500 nm preferred. From the viewpoint of external light-emission efficiency, it is more preferably 3 nm to 200 nm, particularly preferably 5 nm to 100 nm.

The host material may be hole transporting host materials excellent in hole transporting property (which may be referred to as a “hole transporting host”) or electron transporting host compounds excellent in electron transporting property (which may be referred to as an “electron transporting host”).

Examples of the hole transporting host materials contained in the organic light-emitting layer include pyrrole, indole, carbazole, azaindole, azacarbazole, triazole, oxazole, oxadiazole, pyrazole, imidazole, thiophene, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, conductive high-molecular-weight oligomers (e.g., thiophene oligomers and polythiophenes), organic silanes, carbon films and derivatives thereof.

Among them, indole derivatives, carbazole derivatives, aromatic tertiary amine compounds and thiophene derivatives are preferred. Also, compounds each containing a carbazole group in the molecule are more preferred. Further, compounds each containing a t-butyl-substituted carbazole group are particularly preferred.

The electron transporting host to be used in the organic light-emitting layer preferably has an electron affinity Ea of 2.5 eV to 3.5 eV, more preferably 2.6 eV to 3.4 eV, particularly preferably 2.8 eV to 3.3 eV, from the viewpoints of improvement in durability and decrease in drive voltage. Also, it preferably has an ionization potential Ip of 5.7 eV to 7.5 eV, more preferably 5.8 eV to 7.0 eV, particularly preferably 5.9 eV to 6.5 eV, from the viewpoints of improvement in durability and decrease in drive voltage.

Examples of the electron transporting host include pyridine, pyrimidine, triazine, imidazole, pyrazole, triazole, oxazole, oxadiazole, fluorenone, anthraquinonedimethane, anthrone, diphenylquinone, thiopyrandioxide, carbodiimide, fluorenylidenemethane, distyrylpyradine, fluorine-substituted aromatic compounds, heterocyclic tetracarboxylic anhydrides (e.g., naphthalene and perylene), phthalocyanine, derivatives thereof (which may form a condensed ring with another ring) and various metal complexes such as metal complexes of 8-quinolynol derivatives, metal phthalocyanine, and metal complexes having benzoxazole or benzothiazole as a ligand.

Preferred electron transporting hosts are metal complexes, azole derivatives (e.g., benzimidazole derivatives and imidazopyridine derivatives) and azine derivatives (e.g., pyridine derivatives, pyrimidine derivatives and triazine derivatives). Among them, metal complexes are preferred in terms of durability. As the metal complexes (A), preferred are those containing a ligand which has at least one nitrogen atom, oxygen atom, or sulfur atom and which is coordinated with the metal.

The metal ion contained in the metal complex is not particularly limited and may be appropriately selected according to the intended use. It is preferably a beryllium ion, a magnesium ion, an aluminum ion, a gallium ion, a zinc ion, an indium ion, a tin ion, a platinum ion or a palladium ion; more preferably is a beryllium ion, an aluminum ion, a gallium ion, a zinc ion, a platinum ion or a palladium ion; particularly preferably is an aluminum ion, a zinc ion or a palladium ion.

Although there are a variety of known ligands to be contained in the metal complexes, examples thereof include those described in, for example, “Photochemistry and Photophysics of Coordination Compounds” authored by H. Yersin, published by Springer-Verlag Company in 1987; and “YUHKI KINZOKU KAGAKU—KISO TO OUYOU—(Metalorganic Chemistry—Fundamental and Application—)” authored by Akio Yamamoto, published by Shokabo Publishing Co., Ltd. in 1982.

The ligand is preferably nitrogen-containing heterocyclic ligands (preferably having 1 to 30 carbon atoms, more preferably 2 to 20 carbon atoms, particularly preferably 3 to 15 carbon atoms). It may be a unidentate ligand or a bi- or higher-dentate ligand. Preferred are bi- to hexa-dentate ligands, and mixed ligands of bi-dentate to hexa-dentate ligands with a unidentate ligand.

Examples of the ligand include azine ligands (e.g., pyridine ligands, bipyridyl ligands and terpyridine ligands); hydroxyphenylazole ligands (e.g., hydroxyphenylbenzoimidazole ligands, hydroxyphenylbenzoxazole ligands, hydroxyphenylimidazole ligands and hydroxyphenylimidazopyridine ligands); alkoxy ligands (those having preferably 1 to 30 carbon atoms, more preferably 1 to 20 carbon atoms, particularly preferably 1 to 10 carbon atoms, such as methoxy, ethoxy, butoxy and 2-ethylhexyloxy); and aryloxy ligands (those having preferably 6 to 30 carbon atoms, more preferably 6 to 20 carbon atoms, particularly preferably 6 to 12 carbon atoms, such as phenyloxy, 1-naphthyloxy, 2-naphthyloxy, 2,4,6-trimethylphenyloxy and 4-biphenyloxy).

Further examples include heteroaryloxy ligands (those having preferably 1 to 30 carbon atoms, more preferably 1 to 20 carbon atoms, particularly preferably 1 to 12 carbon atoms, examples of which include pyridyloxy, pyrazyloxy, pyrimidyloxy and quinolyloxy); alkylthio ligands (those having preferably 1 to 30 carbon atoms, more preferably 1 to 20 carbon atoms, particularly preferably 1 to 12 carbon atoms, examples of which include methylthio and ethylthio); arylthio ligands (those having preferably 6 to 30 carbon atoms, more preferably 6 to 20 carbon atoms, particularly preferably 6 to 12 carbon atoms, examples of which include phenylthio); heteroarylthio ligands (those having preferably 1 to 30 carbon atoms, more preferably 1 to 20 carbon atoms, particularly preferably 1 to 12 carbon atoms, examples of which include pyridylthio, 2-benzimidazolylthio, 2-benzoxazolylthio and 2-benzothiazolylthio); siloxy ligands (those having preferably 1 to 30 carbon atoms, more preferably 3 to 25 carbon atoms, particularly preferably 6 to 20 carbon atoms, examples of which include a triphenylsiloxy group, a triethoxysiloxy group and a triisopropylsiloxy group); aromatic hydrocarbon anion ligands (those having preferably 6 to 30 carbon atoms, more preferably 6 to 25 carbon atoms, particularly preferably 6 to 20 carbon atoms, examples of which include a phenyl anion, a naphthyl anion and an anthranyl anion); aromatic heterocyclic anion ligands (those having preferably 1 to 30 carbon atoms, more preferably 2 to 25 carbon atoms, and particularly preferably 2 to 20 carbon atoms, examples of which include a pyrrole anion, a pyrazole anion, a triazole anion, an oxazole anion, a benzoxazole anion, a thiazole anion, a benzothiazole anion, a thiophene anion and a benzothiophene anion); and indolenine anion ligands. Among them, nitrogen-containing heterocyclic ligands, aryloxy ligands, heteroaryloxy groups, siloxy ligands, etc. are preferred, and nitrogen-containing heterocyclic ligands, aryloxy ligands, siloxy ligands, aromatic hydrocarbon anion ligands, aromatic heterocyclic anion ligands, etc. are more preferred.

Examples of the metal complex electron transporting host include compounds described in, for example, JP-A Nos. 2002-235076, 2004-214179, 2004-221062, 2004-221065, 2004-221068 and 2004-327313.

In the light-emitting layer, it is preferred that the lowest triplet excitation energy (T1) of the host material is higher than T1 of the phosphorescence light-emitting material, from the viewpoints of color purity, light-emission efficiency and drive durability.

Although the amount of the host compound added is not particularly limited, it is preferably 15% by mass to 95% by mass with respect to the total amount of the compounds forming the light-emitting layer, in terms of light emitting efficiency and drive voltage.

### —Hole-Injection Layer and Hole-Transport Layer—

The hole-injection layer and hole-transport layer are layers having the function of receiving holes from the anode or from the anode side and transporting the holes to the cathode side. Materials to be incorporated into the hole-injection layer or the hole-transport layer may be a low-molecular-weight compound or a high-molecular-weight compound.

Specifically, these layers preferably contain, for example, pyrrole derivatives, carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives and carbon.

Also, an electron-accepting dopant may be incorporated into the hole-injection layer or the hole-transport layer of the organic electroluminescence display device. The electron-accepting dopant may be, for example, an inorganic or organic compound, as long as it has electron accepting property and the function of oxidizing an organic compound.

Specific examples of the inorganic compound include metal halides (e.g., ferric chloride, aluminum chloride, gallium chloride, indium chloride and antimony pentachloride) and metal oxides (e.g., vanadium pentaoxide and molybdenum trioxide).

As the organic compounds, those having a substituent such as a nitro group, a halogen, a cyano group and a trifluoromethyl group; quinone compounds; acid anhydride compounds; and fullerenes may be preferably used.

In addition, there can be preferably used compounds described in, for example, JP-A Nos. 06-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637 and 2005-209643.

Among them, preferred are hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthalene, 1,5-dinitronaphthalene, 9,10-anthraquinone, 1,3,6,8-tetranitrocarbazole, 2,4,7-trinitro-9-fluorenone, 2,3,5,6-tetracyanopyridine and fullerene C60. More preferred are hexacyanobutadiene, hexacyanobenzene, tetracyanoethylene, tetracyanoquinodimethane, tetrafluorotetracyanoquinodimethane, p-fluoranil, p-chloranil, p-bromanil, 2,6-dichlorobenzoquinone, 2,5-dichlorobenzoquinone, 2,3-dichloronaphthoquinone, 1,2,4,5-tetracyanobenzene, 2,3-dichloro-5,6-dicyanobenzoquinone and 2,3,5,6-tetracyanopyridine. Particularly preferred is tetrafluorotetracyanoquinodimethane.

These electron-accepting dopants may be used alone or in combination. Although the amount of the electron-accepting dopant used depends on the type of material, the dopant is preferably used in an amount of 0.01% by mass to 50% by mass, more preferably 0.05% by mass to 20% by mass, particularly preferably 0.1% by mass to 10% by mass, with respect to the material of the hole-transport layer.

The thicknesses of the hole-injection layer and the hole-transport layer are each preferably 500 nm or less in terms of reducing drive voltage. The thickness of the hole-transport layer is preferably 1 nm to 500 nm, more preferably 5 nm to 200 nm, still more preferably 10 nm to 100 nm. The thickness of the hole-injection layer is preferably 0.1 nm to 200 nm, more preferably 0.5 nm to 100 nm, still more preferably 1 nm to 100 nm.

Each of the hole-injection layer and the hole-transport layer may have a single-layered structure made of one or more of the above-mentioned materials, or a multi-layered structure made of a plurality of layers of a homogeneous composition or a heterogeneous composition.

### —Electron-Injection Layer and Electron-Transport Layer—

The electron-injection layer and the electron-transport layer are layers having the functions of receiving electrons from the cathode or the cathode side and transporting the electrons to the anode side. The electron-injection materials or electron-transport materials for these layers may be low-molecular-weight or high-molecular-weight compounds.

Specific examples thereof include pyridine derivatives, quinoline derivatives, pyrimidine derivatives, pyrazine derivatives, phthalazine derivatives, phenanthoroline derivatives, triazine derivatives, triazole derivatives, oxazole derivatives, oxadiazole derivatives, imidazole derivatives, fluorenone derivatives, anthraquinodimethane derivatives, anthrone derivatives, diphenylquinone derivatives, thiopyrandioxide derivatives, carbodiimide derivatives, fluorenylidenemethane derivatives, distyrylpyradine derivatives, aryl tetracarboxylic anhydrides such as perylene and naphthalene, phthalocyanine derivatives, metal complexes (e.g., metal complexes of 8-quinolinol derivatives, metal phthalocyanine, and metal complexes containing benzoxazole or benzothiazole as the ligand) and organic silane derivatives (e.g., silole).

The electron-injection layer or the electron-transport layer in the organic EL element of the present invention may contain an electron donating dopant. The electron donating dopant to be introduced in the electron-injection layer or the electron-transport layer may be any material, as long as it has an electron-donating property and a property for reducing an organic compound. Preferred examples thereof include alkali metals (e.g., Li), alkaline earth metals (e.g., Mg), transition metals including rare-earth metals, and reducing organic compounds. Among the metals, those having a work function of 4.2 eV or less are particularly preferably used. Examples thereof include Li, Na, K, Be, Mg, Ca, Sr, Ba, Y, Cs, La, Sm, Gd and Yb. Also, examples of the reducing organic compounds include nitrogen-containing compounds, sulfur-containing compounds and phosphorus-containing compounds.

In addition, there may be used materials described in, for example, JP-A Nos. 06-212153, 2000-196140, 2003-68468, 2003-229278 and 2004-342614.

These electron donating dopants may be used alone or in combination. The amount of the electron donating dopant used depends on the type of the material, but it is preferably 0.1% by mass to 99% by mass, more preferably 1.0% by mass to 80% by mass, particularly preferably 2.0% by mass to 70% by mass, with respect to the amount of the material of the electron transport layer.

The thicknesses of the electron-injection layer and the electron-transport layer are each preferably 500 nm or less in terms of reducing drive voltage. The thickness of the electron-transport layer is preferably 1 nm to 500 nm, more preferably 5 nm to 200 nm, particularly preferably 10 nm to 100 nm. The thickness of the electron-injection layer is preferably 0.1 nm to 200 nm, more preferably 0.2 nm to 100 nm, particularly preferably 0.5 nm to 50 nm.

Each of the electron-injection layer and the electron-transport layer may have a single-layered structure made of one or more of the above-mentioned materials, or a multi-layered structure made of a plurality of layers of a homogeneous composition or a heterogeneous composition.

### —Hole Blocking Layer—

The hole blocking layer is a layer having the function of preventing the holes, which have been transported from the anode side to the light-emitting layer, from passing toward the cathode side, and may be provided as an organic compound layer adjacent to the light-emitting layer on the cathode side.

Examples of the compound forming the hole blocking layer include aluminum complexes (e.g., BAlq), triazole derivatives and phenanthroline derivatives (e.g., BCP).

The thickness of the hole blocking layer is preferably 1 nm to 500 nm, more preferably 5 nm to 200 nm, particularly preferably 10 nm to 100 nm.

The hole blocking layer may have a single-layered structure made of one or more of the above-mentioned materials, or a multi-layered structure made of a plurality of layers of a homogeneous composition or a heterogeneous composition.

### —Electron Blocking Layer—

An electron blocking layer is a layer having the function of preventing the electrons, which have been transported from the cathode side to the light-emitting layer, from passing toward the anode side, and may be provided as an organic compound layer adjacent to the light-emitting layer on the anode side in the present invention.

Examples of the compound forming the electron blocking layer include those listed as a hole-transport material.

The thickness of the electron blocking layer is preferably 1 nm to 500 nm, more preferably 5 nm to 200 nm, particularly preferably 10 nm to 100 nm.

The electron blocking layer may have a single-layered structure made of one or more of the above-mentioned materials, or a multi-layered structure made of a plurality of layers of a homogeneous composition or a heterogeneous composition.

In order to improve the light-emission efficiency, the light-emitting layer may have such a configuration that charge generation layers are provided between a plurality of light-emitting layers.

The charge generation layer is a layer having the functions of generating charges (i.e., holes and electrons) when an electrical field is applied, and of injecting the generated charges into the adjacent layers.

The material for the charge generation layer is not particularly limited, as long as it has the above-described functions. The charge generation layer may be made of a single compound or a plurality of compounds.

Specifically, the material may be those having conductivity, those having semi-conductivity (e.g., doped organic layers) and those having electrical insulating property. Examples thereof include the materials described in JP-A Nos. 11-329748, 2003-272860 and 2004-39617.

Specific examples thereof include transparent conductive materials (e.g., ITO and IZO (indium zinc oxide)), fullerenes (e.g., C60), conductive organic compounds (e.g., oligothiophene, metal phthalocyanine, metal-free phthalocyanine, metal porphyrins and non-metal porphyrins), metal materials (e.g., Ca, Ag, Al, Mg—Ag alloys, Al—Li alloys and Mg—Li alloys), hole conducting materials, electron conducting materials and mixtures thereof.

As the hole-conductive materials, for example, materials obtained by doping oxidants having an electron-withdrawing property (e.g., F2,3,5,6-tetrafluoro-7,7,8,8-tetracyanoquinodimethane (4-TCNQ), TCNQ and FeCl₃) to hole-transporting organic materials (e.g., 4,4′,4″-tris(2-naphthylphenylamino)triphenylamine (2-TNATA), and N′-dinaphthyl-N,N′-diphenyl[1,1′-biphenyl]-4,4′-diamine (NPD)); P-type conductive polymers, and P-type semiconductors are exemplified. As the electron-conductive materials, for example, materials obtained by doping metals or metallic compounds having a work function of less than 4.0 eV to electron-transporting organic materials, N-type conductive polymers, and N-type semiconductors are exemplified. As the N-type semiconductors, N-type Si, N-type CdS, and N-type ZnS are exemplified. As the P-type semiconductors, P-type Si, P-type CdTe, and P-type CuO are exemplified.

Also, the charge generation layer may be made of electrical insulating materials such as V₂O₅.

The charge generation layer may have a single-layered or multi-layered structure. Examples of the multi-layered structure the charge generation layer has include a structure in which a conductive material (e.g., transparent conductive materials and metal materials) is laminated on a hole or electron transport material, and a structure in which the above-listed hole conducting material is laminated on the above-listed electron conducting material.

In general, the thickness and material of the charge generation layer is preferably determined so that the transmittance thereof with respect to visible light is 50% or higher. The thickness thereof is not particularly limited and may be appropriately determined depending on the intended use. The thickness is preferably 0.5 nm to 200 nm, more preferably 1 nm to 100 nm, still more preferably 3 nm to 50 nm, particularly preferably 5 nm to 30 nm.

The forming method for the charge generation layer is not particularly limited. The above-described forming methods for the organic compound layer may be employed.

The charge generation layer is formed between two or more layers of the above light-emitting layer. The charge generation layer may contain, at the anode or cathode side, a material having the function of injecting charges into the adjacent layers. In order to increase injectability of electrons into the adjacent layers at the anode side, electron injection compounds (e.g., BaO, SrO, Li₂O, LiCl, LiF, MgF₂, MgO and CaF₂) may be deposited on the charge generation layer at the anode side.

In addition to the above-listed materials, the material for charge generation layer may be selected from those described in JP-A No. 2003-45676, and U.S. Pat. Nos. 6,337,492, 6,107,734 and 6,872,472.

### <<Electrode>>

In the present invention, the electrodes are not particularly limited, as long as an electric filed can be applied to the light-emitting layer therefrom. The electrodes may be suitably selected, for example, from transparent or semi-transparent, light reflective or light transmissive anodes or cathodes, depending on the arrangement configuration of the electrodes in the organic electroluminescence display device.

### —Anode—

In general, the anode may be any material, as long as it has the function of serving as an electrode that supplies holes to the organic compound layers constituting the light-emitting layer. The shape, structure, size, etc. thereof are not particularly limited and may be appropriately selected from known electrode materials depending on the application/purpose of the organic electroluminescence display device. As described above, the anode is generally provided as a transparent anode.

Preferred examples of the materials for the anode include metals, alloys, metal oxides, conductive compounds and mixtures thereof. Specific examples include conductive metal oxides such as tin oxides doped with, for example, antimony and fluorine (ATO and FTO); tin oxide, zinc oxide, indium oxide, indium tin oxide (ITO) and indium zinc oxide (IZO); metals such as gold, silver, chromium and nickel; mixtures or laminates of these metals and the conductive metal oxides; inorganic conductive materials such as copper iodide and copper sulfide; organic conductive materials such as polyaniline, polythiophene and polypyrrole; and laminates of these materials and ITO. Among these, conductive metal oxides are preferred. In particular, ITO is preferred from the viewpoints of productivity, high conductivity, transparency, etc.

The anode may be formed on the substrate by a method which is appropriately selected from wet methods such as printing methods and coating methods; physical methods such as vacuum deposition methods, sputtering methods and ion plating method; and chemical methods such as CVD and plasma CVD methods, in consideration of suitability for the material for the anode. For example, when ITO is used as a material for the anode, the anode may be formed in accordance with a DC or high-frequency sputtering method, a vacuum deposition method, or an ion plating method.

In the present invention, a position at which the anode is to be disposed is not particularly limited, as long as the anode is provided so as to come into contact with the light-emitting layer. The position may be appropriately determined depending on the application/purpose of the organic electroluminescence display device. The anode may be entirely or partially formed on one surface of the light-emitting layer.

Patterning for forming the anode may be performed by a chemical etching method such as photolithography; a physical etching method such as etching by laser; a method of vacuum deposition or sputtering using a mask; a lift-off method; or a printing method.

The thickness of the anode may be appropriately selected depending on the material for the anode and is, therefore, not definitely determined. It is generally about 10 nm to about 50 μm, preferably 50 nm to 20 μm.

The resistance of the anode is preferably 10³ Ω/square or less, more preferably 10² Ω/square or less. When the anode is transparent, it may be colorless or colored. For extracting luminescence from the transparent anode side, it is preferred that the anode has a light transmittance of 60% or higher, more preferably 70% or higher.

Concerning transparent anodes, there is a detail description in “TOUMEI DOUDEN-MAKU NO SHINTENKAI (Novel Developments in Transparent Electrode Films)” edited by Yutaka Sawada, published by C.M.C. in 1999, the contents of which can be applied to the present invention. When a plastic substrate having a low heat resistance is used, it is preferred that ITO or IZO is used to form a transparent anode at a low temperature of 150° C. or lower.

### —Cathode—

In general, the cathode may be any material as long as it has the function of serving as an electrode which injects electrons into the organic compound layers constituting the above light-emitting layer. The shape, structure, size, etc. thereof are not particularly limited and may be appropriately selected from known electrode materials depending on the application/purpose of the organic electroluminescence display device.

Examples of the materials for the cathode include metals, alloys, metal oxides, conductive compounds and mixtures thereof. Specific examples thereof include alkali metals (e.g., Li, Na, K and Cs), alkaline earth metals (e.g., Mg and Ca), gold, silver, lead, aluminum, sodium-potassium alloys, lithium-aluminum alloys, magnesium-silver alloys and rare earth metals (e.g., indium and ytterbium). These may be used individually, but it is preferred that two or more of them are used in combination from the viewpoint of satisfying both stability and electron-injection property.

Among these, as the materials for forming the cathode, alkali metals or alkaline earth metals are preferred in terms of excellent electron-injection property, and materials containing aluminum as a major component are preferred in terms of excellent storage stability. The term “material containing aluminum as a major component” refers to a material composed of aluminum alone; alloys containing aluminum and 0.01% by mass to 10% by mass of an alkali or alkaline earth metal; or the mixtures thereof (e.g., lithium-aluminum alloys and magnesium-aluminum alloys).

The materials for the cathode are described in detail in JP-A Nos. 02-15595 and 05-121172. The materials described in these literatures can be used in the present invention.

The method for forming the cathode is not particularly limited, and the cathode may be formed by a known method. For example, the cathode may be formed by a method which is appropriately selected from wet methods such as printing methods and coating methods; physical methods such as vacuum deposition methods, sputtering methods and ion plating methods; and chemical methods such as CVD and plasma CVD methods, in consideration of suitability for the material for the cathode. For example, when a metal (or metals) is (are) selected as a material (or materials) for the cathode, one or more of them may be applied simultaneously or sequentially by a sputtering method.

Patterning for forming the cathode may be performed by a chemical etching method such as photolithography; a physical etching method such as etching by laser; a method of vacuum deposition or sputtering using a mask; a lift-off method; or a printing method.

In the present invention, a position at which the cathode is to be disposed is not particularly limited, as long as the cathode can apply an electric field to the light-emitting layer. The cathode may be entirely or partially formed on the light-emitting layer.

Furthermore, a dielectric layer having a thickness of 0.1 nm to 5 nm and being made, for example, of fluorides and oxides of an alkali or alkaline earth metal may be inserted between the cathode and the organic compound layer. The dielectric layer may be considered to be a kind of electron-injection layer. The dielectric layer may be formed by, for example, a vacuum deposition method, a sputtering method and an ion plating method.

The thickness of the cathode may be appropriately selected depending on the material for the cathode and is, therefore, not definitely determined. It is generally about 10 nm to about 5 μm, and preferably 50 nm to 1 μm.

Moreover, the cathode may be transparent, semi-transparent or opaque. The transparent cathode may be formed as follows. Specifically, a film having a thickness of 1 nm to 10 nm is formed from a material for the cathode, and a transparent conductive material (e.g., ITO and IZO) is laminated on the thus-formed film.

### <<Substrate>>

The shape, structure, size, material and the like of a substrate for use in the OLED substrate may be suitably selected in accordance with the intended use. In general, as the shape, the substrate preferably has a plate shape. As the structure, the substrate may have a single-layered structure or a multi-layered structure. In addition, the substrate may be made of a single material or two or more materials. Although the substrate may be colorless transparent or may be colored transparent, it is preferably colorless transparent in terms of no scattering or attenuation of the light emitted from the light-emitting layer. In addition, the substrate preferably has flexibility in terms of the convenience. The OLED substrate may be made of the same material as that used in the above-mentioned light transmissive substrate of the organic member. An aspect of the arrangement (location) of the OLED substrate may be suitably selected in accordance with the intended use, as long as it is an aspect having no influence on emission and transmittance of light from the OLED substrate. However, the substrate may be disposed on the side opposite to the organic EL layer, as viewed from the light reflective electrodes, so that the substrate is not disposed on an optical path of light emitted from the OLED substrate.

### <Driving>

The organic electroluminescence display device can emit light when a DC voltage (which, if necessary, contains AC components) (generally 2 volts to 15 volts) or a DC is applied to between the anode and the cathode.

For the driving method of the organic EL layer, applicable are those described in, for example, JP-A Nos. 02-148687, 06-301355, 05-29080, 07-134558, 08-234685 and 08-241047, Japanese Patent No. 2784615, and U.S. Pat. Nos. 5,828,429 and 6,023,308.

### EXAMPLES

Next, the present invention will be described in detail by way of Examples and Comparative Example. However, the present invention is not construed as being limited to the following Examples.

### Example 1

### <Production of Optical Member>

### <<Production of Mold for Optical Member>>

A photosensitive resist was applied onto a quartz substrate by spin-coating, a pattern exposure was perfumed by selectively irradiating the resist film so as to correspond to a pixel composed of subpixels of any one of colors of red, blue and white, and openings were provided at predetermined positions in the surface of the quartz substrate by a photolithographic process. Thereafter, the openings were further etched to a predetermined depth by dry-etching. In addition, the patterning of the resist film and dry-etching were repeatedly performed so as to correspond to other subpixels and other pixels.

The photosensitive resist was etched at a region to form a concave portion corresponding to a green pixel and being 98 nm away from a surface of the quartz substrate; at a region to form a concave portion corresponding to a blue pixel and being 258 nm away from the surface of the quartz substrate: regions corresponding to convex portions for partitioning plural pixels were etched, and a region corresponding to a white pixel and being 278 nm away from the surface of the quartz substrate were etched. A concave portion corresponding to a red pixel was not etched. With the above procedure, a mold for use in forming concave-convex portions (concave-convex-portion-forming mold) was obtained. Note that the depths of concave portions in the thus obtained concave-convex-portion-forming mold are as follows:

### [Depth of Concave Portion in Mold for Optical Member]

Concave portion corresponding to red color: (depth: 0 nm)

Concave portion corresponding to green color: (depth: 98 nm)

Concave portion corresponding to blue color: (depth: 258 nm)

Concave portion corresponding to white color and inter-pixels: (depth: 278 nm)

### <<Optical Member>>

<<<Light Transmissive Substrate having Color Filter Layer>>>

A black color resist CK-8400 (produced by Fuji Film Electronics Materials Co., Ltd.) was applied to a glass substrate for use in producing a color filter using a spin coater so as to have a dry thickness of 1.0 μm, and dried at 120° C. for 2 minutes, thereby forming a black color coat film uniform in thickness.

Next, using an exposing device, the coat film was exposed to light having a wavelength of 365 nm with an exposure dose of 300 mJ/cm² via a mask of 100 μm in thickness. After the irradiation, the coat film was developed at 26° C. for 90 seconds using a 10% by mass of CD-1 (produced by Fuji Film Electronics Materials Co., Ltd.) developer liquid. Subsequently, the developed coat film was rinsed with wash for 20 seconds, followed by drying with an air knife and heating at 220° C. for 60 minutes, thereby forming a pattern image of a black matrix.

Next, curable compositions of the following three colors were each dispersed by a sand mill for one day. Dispersion liquids obtained for each color of green, red and blue are called Dispersion Liquids (A-1), (A-2) and (A-3), respectively.

### [Green Color: Dispersion Liquid (A-1)]

| | |
|---|---|
| Benzylmethacrylate/methacrylic acid copolymer | 80 parts by mass |
| (weight average molecular weight: 30,000; | |
| acid value: 120) | |
| Propylene glycol monomethylether acetate | 500 parts by mass |
| Copper phthalocyanine pigment | 33 parts by mass |
| C.I. Pigment Yellow 185 | 67 parts by mass |

### [Red Color: Dispersion Liquid (A-2)]

| | |
|---|---|
| Benzylmethacrylate/methacrylic acid copolymer | 80 parts by mass |
| (weight average molecular weight: 30,000, | |
| acid value: 120) | |
| Propylene glycol monomethylether acetate | 500 parts by mass |
| Pigment Red 254 | 50 parts by mass |
| Pigment Red PR177 | 50 parts by mass |

### [Blue Color: Dispersion Liquid (A-3)]

| | |
|---|---|
| Benzylmethacrylate/methacrylic acid copolymer | 80 parts by mass |
| (weight average molecular weight: 30,000, acid | |
| value: 120) | |
| Propylene glycol monomethylether acetate | 500 parts by mass |
| Pigment Blue 15:6 | 95 parts by mass |
| Pigment Violet 23 | 5 parts by mass |

Next, the following components were added to the above-mentioned curable composition for each of the respective colors (i.e., Dispersion Liquids (A-1), (A-2) and (A-3)) (60 parts by mass) to obtain a composition for each color.

| | |
|---|---|
| Dipentaerythritol hexaacrylate (DPHA) | 80 parts by mass |
| 4-[o-bromo-p-N,N- | 5 parts by mass |
| di(ethoxycarbonyl)aminophenyl]2,6- | |
| di(trichloromethyl)-S-triazine | |
| 7-[{4-chloro-6-(diethylamino)-S-triazin-2- | 2 parts by mass |
| yl}amino]-3-phenyl-coumarin | |
| Hydroquinone monomethylether | 0.01 parts by mass |
| Propylene glycol monomethylether acetate | 500 parts by mass |

Each of the compositions for each color obtained by addition of the above-mentioned components was uniformly mixed and then filtered through a membrane filter (5 μm pore diameter) to thereby obtain curable compositions of three colors of the present invention. Of these compositions, the green-color curable composition was applied onto the glass substrate with the black matrix pattern formed thereon using a spin-coater so as to have a dry thickness of 1.0 μm and dried at 120° C. for 2 minutes, thereby forming a green-color coat film uniform in thickness.

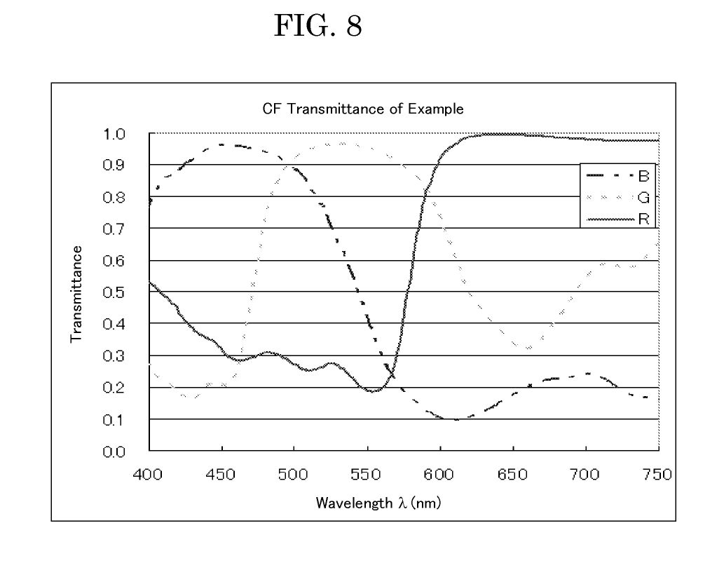

Next, using an exposing device, the coat film was exposed to light having a wavelength of 365 nm with an exposure dose of 300 mJ/cm² via a mask of 100 μm in thickness. After the irradiation, the coat film was developed at 26° C. for 60 seconds using a 10% CD-1 (produced by Fuji Film Electronics Materials Co., Ltd.) developer liquid. Subsequently, the developed coat film was rinsed with wash for 20 seconds, followed by drying with an air knife and heating at 220° C. for 60 minutes, thereby forming a green-color pattern image (green pixels). Similarly, this treatment was performed for the red-color curable composition and the blue-color curable composition, on each of the same type glass substrates to form a red-color pattern image (red pixels) and a blue-color pattern image (blue pixels), in this order. Optical properties of the color filter substrate are illustrated in FIG. 8.

### <<<Light Transmissive Layer>>>

Next, the following component was applied onto a light transmissive substrate having the thus formed color filter layer, by spin-coating to form a light transmissive layer (thickness: 1,000 nm).

### [Light Transmissive Layer]

The light transmissive layer was formed using PAK-02 (produced by Toyo Gosei Co., Ltd.).

On the thus obtained light transmissive layer, concave-convex portions were formed by a transfer method, using the concave-convex-portion-forming mold obtained as described above. The mold was pressed against the light transmissive layer, and an UV ray was applied to the light transmissive layer from the side of the mold made of a quartz substrate so as to cure the material of the light transmissive layer to thereby form concave portions in the surface of the layer.

On the surface provided with the thus obtained concave and convex portions in the light transmissive layer, Ag was deposited by a vacuum evaporation method to form a light semi-transmissive reflecting layer (thickness: 10 nm), thereby obtaining an optical member.

### [Conditions for Forming Light Semi-Transmissive Reflecting Layer]

The light semi-transmissive reflecting layer is formed by a common vacuum evaporation method using Ag and selectively forming a film via a metal mask so that the required portions of area are film-formed. In particular, white-color subpixels emit light having a spectrum of the light source, and thus no light semi-transmissive reflecting layer is formed to avoid forming an optical resonator structure. Further, as illustrated in FIG. 1, in the case of a configuration where convex portions formed at an light transmissive layer of an optical member are bonded with a coupling agent, an organic material is made to remain on top surfaces of the convex portions, the top surfaces serving as bonded surfaces, and thus the light transmissive layer corresponding to these portions are also exposed, and no light semi-transmissive reflecting layer is formed on these portions.

A difference in step height between the surface of the light transmissive layer in the optical member and the surface of the light semi-transmissive reflecting layer in the concave portions partially acts as an optical resonator length. The amounts of difference in step height therebetween are described below as depth sizes.

### [Concave Portions of Optical Member]

Concave portion corresponding to red color: (depth: 268 nm)

Concave portion corresponding to green color: (depth: 170 nm)

Concave portion corresponding to blue color: (depth: 10 nm)

Concave portion corresponding to white color and inter-pixels: (depth: 0 nm)

### <Production of OLED Substrate>

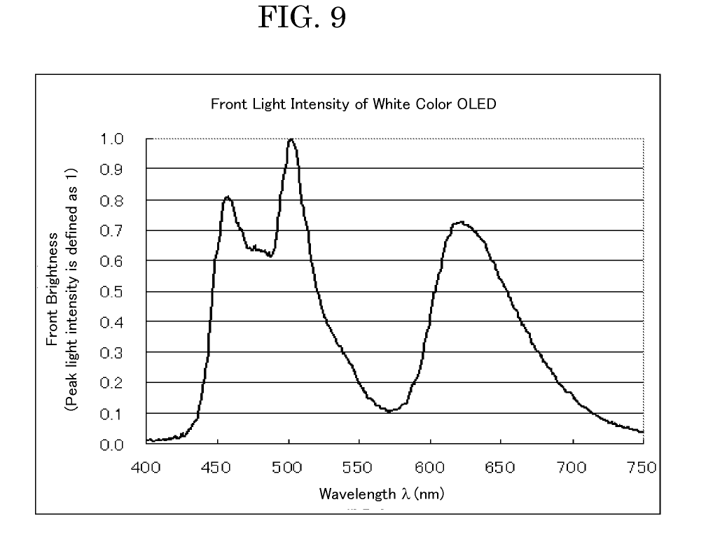

Over a substrate on which a reflective electrode made of Al had been formed, organic layers were formed by vacuum evaporation and a transparent electrode layer were formed by ion-plating, in this order, to thereby produce an OLED substrate. Light emission characteristics of the OLED substrate are illustrated in FIG. 9.

### [Electron Injection Layer]

Material: LiF

Evaporation rate: 0.1 angstroms/sec

Film forming time: 100 sec

Thickness: 10 angstroms=1 nm

### [Electron Transport Layer]

Material: BAlq

Evaporation rate: 1 angstrom/sec

Film forming time: 100 sec

Thickness: 100 angstroms=10 nm

### [Light Emitting Layer (Blue)]

Material: Co-evaporation of mCP (host) with a light emitting material (D-24 described above) (guest)

Evaporation rate: mCP=0.9 angstroms/sec, Light emitting material B=0.1 angstroms/sec

Film forming time: 100 sec

Thickness: 100 angstroms=10 nm

### [Light Emitting Layer (Green)]

Material: Co-evaporation of mCP (host) with a light emitting material (D-22 described above) (guest)

Evaporation rate: mCP=0.9 angstroms/sec, Light emitting material G=0.1 angstroms/sec

Film forming time: 150 sec

Thickness: 150 angstroms=15 nm

### [Light Emitting Layer (Red)]

Material: Co-evaporation of BAlq (host) with a light emitting material (D-7 described above) (guest)

Evaporation rate: BAlq=0.9 angstroms/sec, Light emitting material R=0.1 angstroms/sec

Film forming time: 200 sec

Thickness: 200 angstroms=20 nm

### [Hole Transport Layer]

Material: a-NPD

Evaporation rate: 1 angstrom/sec

Film forming time: 100 sec

Thickness: 100 angstroms=10 nm

### [Hole Injection Layer]

Material: Co-evaporation of 2-TNATA (host) with F4-TCNQ

Evaporation rate: 2-TNATA=2 angstroms/sec, F4-TCNQ=0.1 angstroms/sec

Film forming time: 48 sec

Thickness: 100 angstroms=10 nm

### [Transparent Electrode Layer]

Material: ITO

Evaporation rate: 50 angstroms/sec

Film forming time: 200 sec

Thickness: 1,000 angstroms=100 nm

### <Bonding of Optical Member and OLED Substrate>

### [Synthesis of Compound A]

A compound A for use in bonding an optical member with an OLED substrate was synthesized according to the following procedure. Note that this synthesis was carried out through the following two steps.

1. Step 1 (Synthesis of Compound a)

In a mixed solvent of DMAc (50 g) and THF (50 g), 1-hydroxycyclohexyl phenyl ketone [(24.5 g) (0.12 mol)] was dissolved and NaH (60% in oil) [7.2 g (0.18 mol)] was slowly added in the mixed solvent while cooling the mixed solvent under an ice bath. Then, 11-bromo-1-undecene (95%) [44.2 g (0.18 mol)] was added dropwise thereinto and reacted at room temperature for 1 hour. The reaction solution was poured into iced water, followed by extraction with ethyl acetate, thereby obtaining a mixture containing a “Compound a” staying in a yellow solution state. This mixture (37 g) was dissolved in acetonitrile (370 mL) and water (7.4 g) was added thereto. Then, p-toluene sulfonate monohydrate (1.85 g) was added to the mixture and stirred at room temperature for 20 minutes. An organic phase was extracted, with ethyl acetate, from the mixture, and the solvent contained in the organic phase was distilled away therefrom. “Compound a” was isolated from the organic phase by column chromatography using (filler: WAKO-GEL C-200, developing solvent: ethyl acetate/hexane=1/80). The scheme of this synthesis is described below.

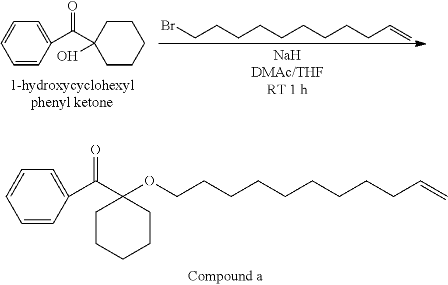

¹H NMR (300 MHz CDCl₃)

δ=1.2-1.8(mb, 24H), 2.0 (q, 2H), 3.2 (t,J=6.6,2H), 4.9-5.0 (m, 2H) 5.8 (ddt,J=24.4, J=10.5,J=6.6,1H.), 7.4 (t,J=7.4,2H), 7.5 (t,J=7.4,1H), 8.3(d, 1H)

2. Step 2 (Synthesis of Compound A by hydrosilylation of Compound a)

Two droplets of Speir catalyst (H₂PtCl₆/6H₂O/2-PrOH, 0.1 mol/L) were added to the Compound a [(5.0 g) (0.014 mol)], and trichlorosilane [2.8 g (0.021 mol)] was added dropwise into the compound while cooling it under an ice bath and stirred. One hour later, trichlorosilane [1.6 g (0.012 mol)] was further added dropwise thereinto, and left standing until the temperature of the system was returned naturally to room temperature. Three hours later, the reaction was completed. Upon completion of the reaction, unreacted trichlorosilane was distilled away under reduced pressure, thereby obtaining Compound A.

This synthesis scheme is described below.

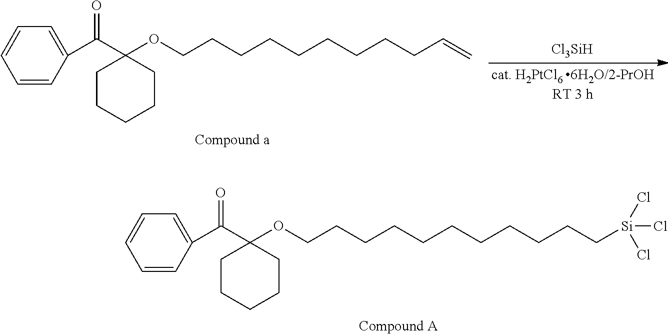

¹H NMR (300 MHz CDCl₃)

δ=1.2-1.8 (m, 30H), 3.2 (t,J=6.3, 2H), 7.3-7.7 (m, 3H), 8.3 (d, 2H)

(Step of Coating Solution onto OLED Substrate)

A dehydrated toluene solution of Compound A (12.5% by mass) was applied to a surface of the transparent electrode layer of the OLED substrate and then dried by air at room temperature.

(Bonding of OLED Substrate with Optical Member)

Bonding of an optical member to an OLED substrate is performed by one of Methods 1 and 2 described below. However, particularly when an UV irradiation cannot be performed to portions to be bonded (i.e., in the case where the portion to be bonded is hidden by a color filter, etc.), the optical member is bonded to the OLED substrate by Method 2. When a black matrix is not to be included in a color filter layer, an optical member is bonded to an OLED substrate by irradiating an UV ray from the light transmissive substrate side of the optical member via the light transmissive substrate and a light transmissive layer by Method 1.

1. The transparent electrode side (inorganic material surface) of the OLED substrate, to which surface Compound A has been applied, is closely contacted with the top surfaces (organic material surfaces) of convex portions of the light transmissive layer in the optical member, and the OLED substrate and the optical member are subjected to UV exposure, thereby combining the optical member with the OLED substrate.

2. A 0.1% AIBN (azobisbutylonitrile) methanol solution is applied to the top surfaces (organic material surfaces) of convex portions, and the transparent electrode side (inorganic material surface) of the OLED substrate, to which surface Compound A has been applied, is closely contacted with the top surfaces, and reacted at 80° C. over 12 hours, thereby combining the optical member with the OLED substrate.

### Example 2

An organic electroluminescence display device was obtained in the same manner as in Example 1, except that instead of bonding the optical member to the OLED substrate using a coupling agent, the bonding was performed under the following conditions.

In order to form concave portions in a light transmissive layer of an optical member, a mold for optical member having concave portions with the following depth sizes was used to thereby obtain the optical member having concave portions with the following depth sizes.

### [Concave Portion of Mold for Optical Member]

Concave portion corresponding to red color: (depth: 0 nm)

Concave portion corresponding to green color: (depth: 97 nm)

Concave portion corresponding to blue color: (depth: 293 nm)

Concave portion corresponding to white color and inter-pixels: (depth: 313 nm)

### [Depth of Concave Portion of Optical Member]

Concave portion corresponding to red color: (depth: 303 nm)

Concave portion corresponding to green color: (depth: 206 nm)

Concave portion corresponding to blue color: (depth: 10 nm)

Concave portion corresponding to white color and inter-pixels: (depth: 0 nm)

SiN particles were dispersed in the concave portions of the obtained optical member according to an inkjet method to be filled with an epoxy-based adhesive having a refractive index equivalent to that of the transparent electrode layer of the OLED substrate. As the conditions for filling, the filling was performed so that bottom portions of the formed concave portions and the surface of the optical member defined by convex portions were filled with the adhesive in prescribed capacities.

### Comparative Example

An optical member having, on its surface, no light transmissive layer (i.e., a simple color filter substrate) was overlaid on an OLED substrate and combined into an integral unit to thereby obtain an organic electroluminescence display device. Both the OLED substrate and the color filter each have the same constitution and properties as those described above.

### <Evaluation>

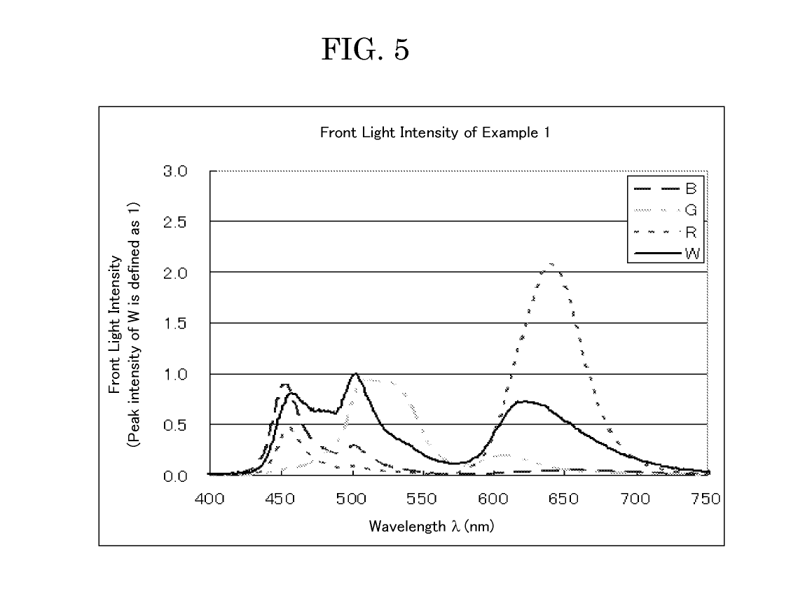

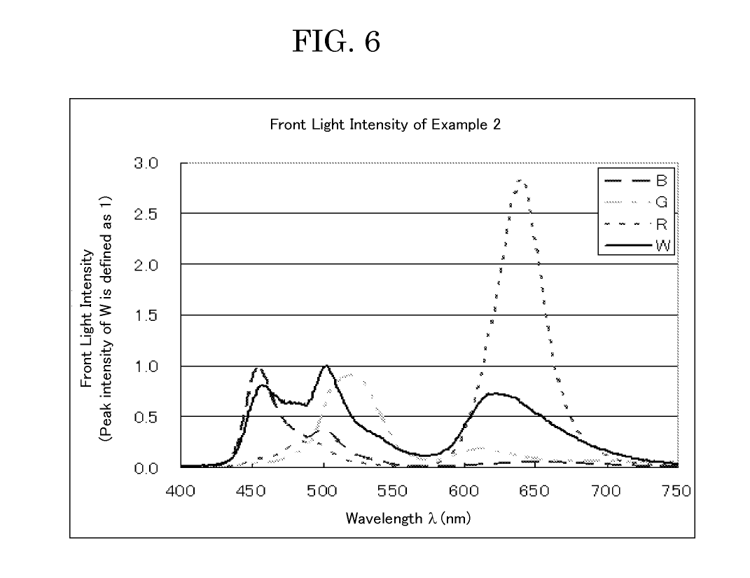

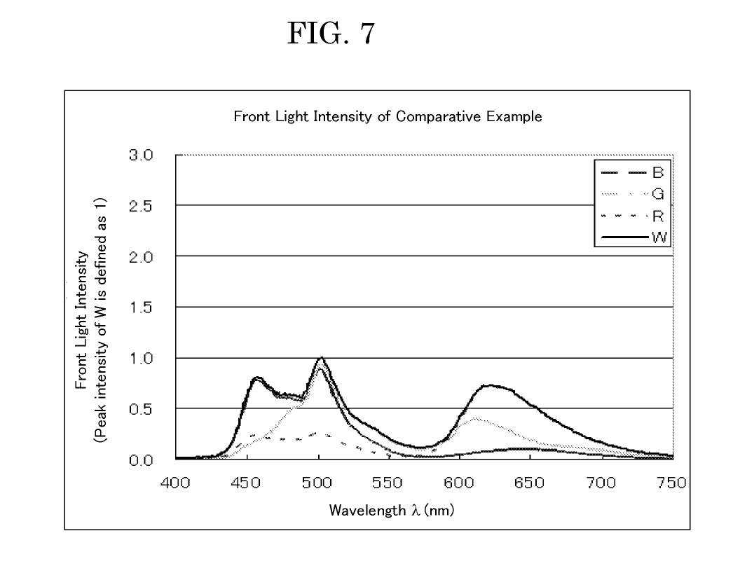

Using the organic electroluminescence display devices obtained in Examples 1 and 2 and Comparative Example, spectra of front light intensity of light emitted from each pixel were measured under the following conditions. The measurement results are illustrated in FIGS. 5, 6 and 7. Here, the maximum intensity (peak intensity) of white light (W) is defined as 1, and front light intensities measured are normalized using the maximum intensity as a reference light intensity, and compared with each other.

In an organic electroluminescence display device of Comparative Example, the wavelength of white light as a light source was selected at the color filter, however, the maximum transmittance of each of the blue (B) green (G), red (R) color lights was 1 or lower. Therefore, the front light intensity of each of these colors was 1 or lower, and the wavelength distributions thereof became broad in accordance with optical properties of the color filter. That is, the organic electroluminescence display device was weak in light intensity and poor in light emission output of each color.

In contrast, in organic electroluminescence display devices of Examples, light intensities of the lights of blue (B), green (G) and red (R) each having a predetermined wavelength were increased, and a narrow wavelength distributions was obtained for each color. That is, the lights emitted from the organic electroluminescence display devices of Examples have strong light intensities and excellent light emission output of each color. In Examples, it was possible to obtain organic electroluminescence display devices having enhanced display properties by using an optical member according to the present invention.

An optical member according to the present invention can be suitably used for a substrate which is provided on the light emitting side of an organic light-emitting display device having a white light source, and since the organic light emitting display device enables high brightness, full-color display, it can be suitably used in a wide variety of fields including displays of mobile phones, personal digital assistant (PDA), computer display, information display in automobiles, monitors of television set, and typical illumination.

What is claimed is:

1. An optical member disposed on the light emitting side of an organic light-emitting display device having at least a light reflective electrode and an organic EL layer, the optical member comprising:
a light transmissive substrate, and
a light transmissive layer which is formed on the light transmissive substrate and which has concave portions,
wherein the optical member is disposed on the light emitting side of the organic light-emitting display device, the optical member forming an optical resonator between the light reflective electrode in the organic light-emitting display device and surfaces of the concave portions opposite to the light reflective electrode, and
wherein the optical resonator emits at least one color light selected from a red light, a green light and a blue light.

2. The optical member according to claim 1, wherein the light transmissive layer is formed of one structural member.

3. The optical member according to claim 2, wherein the one structural member is made of a material selected from a photocurable resin, a thermoplastic resin and a thermally curable resin.

4. The optical member according to claim 1, further comprising a light semi-transmissive reflecting layer on a surface of the light transmissive layer, in which surface the concave portions are formed.

5. The optical member according to claim 1, wherein the concave portions provided in the light transmissive layer are different in depth so that at least one of a red light, a green light and a blue light is emitted from the organic light-emitting device.

6. The optical member according to claim 1, further comprising a color filter layer between the light transmissive substrate and the light transmissive layer.

7. The optical member according to claim 1, wherein the light transmissive substrate has flexibility.
